(19) United States
(12) Patent Application Publication
(10) Pub. No.: US 2010/0131881 A1
(43) Pub. Date: May 27, 2010

(54) Apparatus and Method for Data Search and Organization

(76) Inventor: Jayasenan Sundara Ganesh, Cupertino, CA (US)

Correspondence Address: COURTNEY STANIFORD & GREGORY LLP, 10001 N. De Anza Blvd., Suite 300, Cupertino, CA, 95014, US

(21) Appl. No.: 12/582,701

(22) Filed: Oct. 20, 2009

Related U.S. Application Data
(60) Provisional application No. 61/196,832, filed on Oct. 20, 2008.

(51) Int. Cl. G06F 17/30; G06F 3/048

(52) U.S. Cl. 715/769; 707/770; 715/843; 715/834; 707/E17.032

(57) ABSTRACT

Embodiments of the invention include a browser component and one or more server components that facilitate easy electronic search and selection of data via any network. Embodiments further comprise an intuitive user interface for the browser. Embodiments further include a method for performing searches and assembling data from anywhere on a variety of networks according to user specifications as directed through the browser and intuitive user interface. The searchable data can be of any type electronically representable. For most of this description, identifiable objects in the context of online shopping are used as an example. Data or objects can be physical objects such as merchandise, books in a library, etc., or representations of non-physical objects such as customer support problems, legal case descriptions, etc. The apparatus and method is also used for defining a new object, or searching existing well-defined objects. The apparatus and method enables a user to define search criteria in a much more intuitive and easy manner than when using existing methods.

### RELATED APPLICATIONS

This application claims priority from U.S. Provisional Patent Application No. 61/196,832, filed Oct. 20, 2008, which is incorporated by reference in its entirety herein.

### TECHNICAL FIELD

Embodiments described herein are related to electronically searching and grouping data.

### BACKGROUND

Today's internet browsers (such as Mozilla™ Firefox™, Internet Explorer™, Netscape Navigator™, Google Chrome™, Apple Safari™, etc.) and similar applications present web pages using HTML and Javascript™ applets. Websites that seek to cater to specific set of users take care to present their web pages in a pre-configured or static manner. Even programmatically generated web pages (for example using personal home page (“PHP” hypertext preprocessor)) are generated following a particular skeleton as opposed to the semantics of the pages. Some websites (such as Yahoo!™ And Google™) provide their users with capabilities to arrange components in a web page dynamically for ease of use and flexibility, for example to retain or eliminate components based on their interest and relevance. Even in these personalized pages, the arrangement of different components is static after rearrangement, until the user rearranges them again.

Many websites, especially shopping websites, present information in a predetermined, static manner. As an example, Amazon.com™ presents its home page with all the shopping categories on the left side and the selectable menu items at the top, etc. This is typical of most shopping websites. In subsequent web pages (presented when one clicks a category or selects a menu item), the arrangement is very similar. Currently, there is no capability to arrange web pages, or information from several web pages, according to a user's interest in selecting groups of items to be displayed on the screen based on some of the items' attributes or qualities chosen by the user. This would be desirable to have such a capability for the purposes of avoiding clutter and/or eliminating categories that are of no interest to the user in a particular shopping context. Also, users currently must navigate websites according to the arrangement laid out by a particular vendor. For example, in order to browse “Nike's Men's blue walking shoes”, one must traverse “Shoes->Men->‘Athletic & Outdoor’->Walking” and then “brand->Nike”, then “Color->Blue”. There may be small variations of navigation available (such as Men->Shoes), but the paths of navigations for reaching an object of interest are typically predetermined. Today, it is almost impossible to locate objects in an arbitrary fashion—in this case, “Blue->Men->Nike->Walking->Shoes”. More specifically, it is not currently possible to easily locate and assemble objects in an arbitrary fashion among multiple websites that potentially offer the objects of interest for sale or examination, or offer data for research. This desired, but currently unavailable, ability to easily select and organize data can be illustrated using the online shopping example, but the capability is just as well applied to searching for, selecting and organizing any types of data on a network.

Typical shopping websites support “wish list” features by which a consumer can add any interesting items seen during a browsing session. Although the wish list could be used for any other purpose than the purpose of wishing to buy the item, the wish list concept is normally used as a temporary private data storage holding items of interest for future handling. The relationships between various items in the wish list have not been utilized for the benefit of the consumers so far. It would further be desirable to extend wish lists to exploit the relationships amongst items in the list in terms of their attributes and values

### BRIEF DESCRIPTION OF THE DRAWINGS

FIG. 1 is a block diagram of a system 100 according to an embodiment.

FIG. 2 is a block diagram of a system 200 according to an embodiment.

FIG. 3 is a block diagram of a system 300 according to an embodiment.

FIG. 4A is a diagram of a user interface screen according to an embodiment.

FIG. 4B is similar to FIG. 4A, but using polygonal wedges.

FIG. 4C is similar to FIG. 4A, but using bean and bin wedges.

FIG. 5 is a flow chart showing a sequence of operations to build an expression according to an embodiment.

FIG. 6A is a diagram illustrating the use of the central circle according to an embodiment.

FIG. 6B is a diagram of a user interface illustrating data from which wedges can be created according to an embodiment.

FIG. 7 is a diagram of a user interface illustrating container wedges and contained wedges according to an embodiment.

FIGS. 8A and 8B are diagrams illustrating wedge fitting and placement in a user interface according to an embodiment.

FIG. 9 is a diagram illustrating 5 minimized wedges next to each other, which could be collapsed into a single minimized wedge according to an embodiment.

FIGS. 10A and 10B are illustrations of screenshots of the user interface with a number of wedges placed and colored using algorithms of an embodiment.

FIGS. 11A and 11B are diagrams illustrating a fish-eye technique of showing further detail of a focus wedge according to an embodiment.

FIG. 12 is a diagram showing items (such as list of products satisfying the resultant expression) of a wedge or other enumerated list of information displayed as a scrollable carousel within the wedge according to an embodiment.

FIG. 13 is a diagram illustrating how complex expressions can be created easily using navigation methods according to an embodiment.

FIG. 14 is an illustration of the user interface after “W1” shown in FIG. 12 is zoomed according to an embodiment.

FIG. 15 is an illustration of the user interface after “W1” shown in FIG. 12 is maximized.

FIGS. 16A and 16B are diagrams showing a sequence of steps for creating a wedge according to an embodiment.

17A and 17B are diagrams illustrating steps involved in creating a wedge arrangement according to an embodiment.

FIGS. 18A and 18B are diagrams similar to FIGS. 17A and 17B, but using bean and bin wedges.

FIG. 19 is a diagram illustrating the wedge arrangement representing an expression according to an embodiment.

FIG. 20 is a diagram illustrating the results of an expression in the form of a list with various columns according to an embodiment.

FIG. 21 is a diagram illustrating a wedge or section showing results of an expression according to an embodiment.

### DETAILED DESCRIPTION

Embodiments of the invention include a browser component and one or more server components that facilitate easy electronic search and selection of data via any network. Embodiments further comprise an intuitive user interface for the browser. Embodiments further include a method for performing searches and assembling data from anywhere on a variety of networks according to user specifications as directed through the browser and intuitive user interface. The searchable data can be of any type electronically representable. For most of this description, identifiable objects in the context of online shopping are used as an example. Data or objects can be physical objects such as merchandise, books in a library, etc., or representations of non-physical objects such as customer support problems, legal case descriptions, etc. The apparatus and method is also used for defining a new object, or searching existing well-defined objects. The apparatus and method enables a user to define search criteria in a much more intuitive and easy manner than when using existing methods. The deployment of the apparatus can be over any network such as Local Area Networks (LAN), Wide Area Networks (WAN), Wireless LAN (WLAN), Private Networks, Virtual Private Networks (VPN), Internet, etc. or could be a set of self-contained applications running on a single computer to search data stored in a specific location.

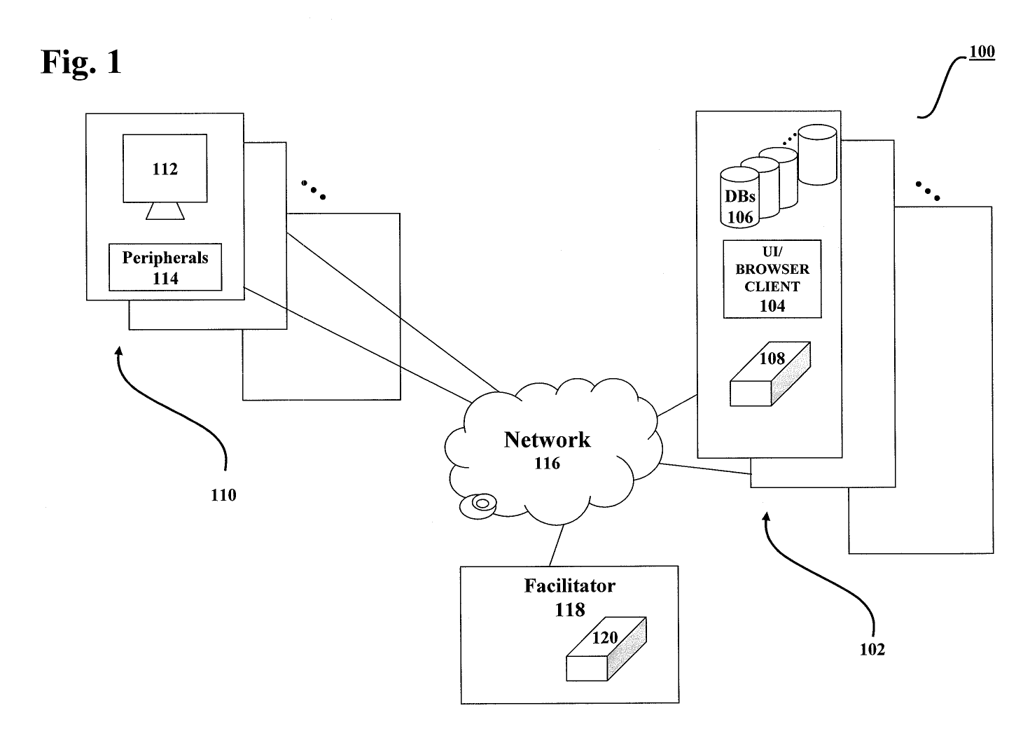

FIG. 1 is a block diagram of a system 100 according to an embodiment. System 100 includes a facilitator 118, which for purposes of this description, is hardware and software maintained by an entity on a network to provide the apparatus and method disclosed herein. Facilitator 118 includes one or more servers 120. Facilitator 118 communicates via a network 116 with any other entities on the network 116. As previously described, network 116 can be any type of local network, wide area network, or global network, but is typically the Internet. System 100 further includes multiple data source entities 102. Each of data source entities 102 includes one or more databases 106, and one or more servers 108. In an embodiment, data source entities further include a user interface/browser client 104 (UI/browser client 104) that resides on a data source entity 102 after being provided by facilitator 118. Details of UI/browser client 104 are provided with reference to additional figures below.

System 100 further includes multiple end user systems 110. Each end user system 110 includes a display device 112 and multiple peripheral devices 114. As further described below, end users make use of UI/browser client 104 via network 116 for executing the methods disclosed.

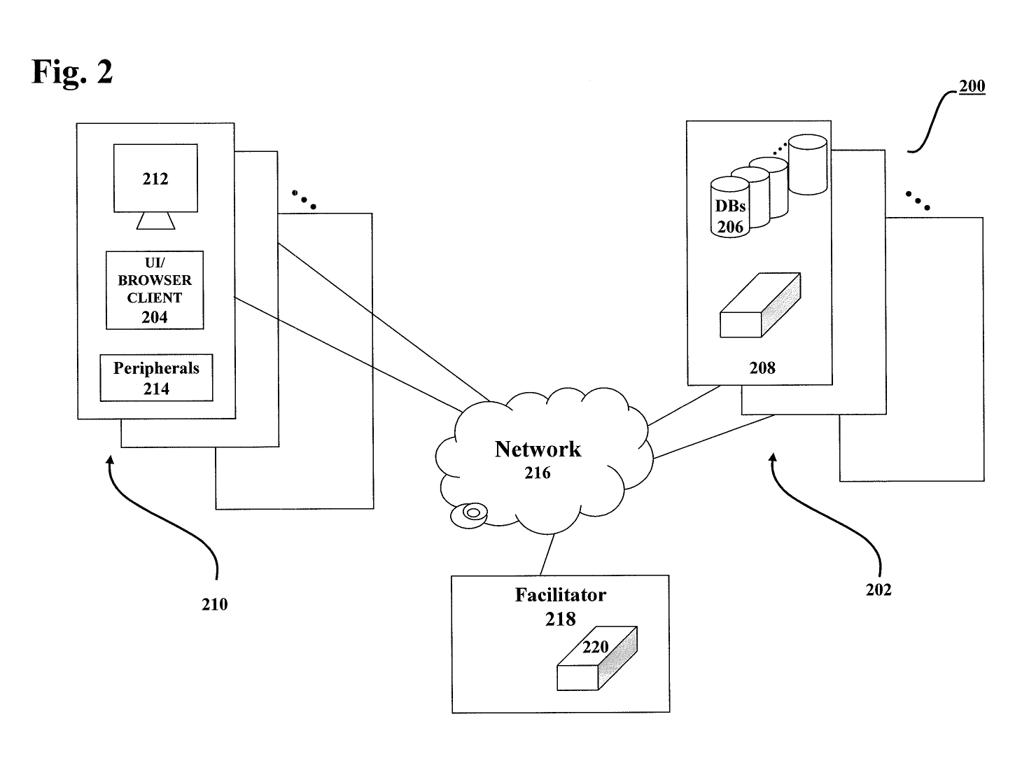

FIG. 2 is a block diagram of a system 200 according to an embodiment. System 200 includes a facilitator 218, which for purposes of this description, is hardware and software maintained by an entity on a network to provide the apparatus and method disclosed herein. Facilitator 218 includes one or more servers 220. Facilitator 218 communicates via a network 216 with any other entities on the network 216. As previously described, network 216 can be any type of local network, wide area network, or global network, but is typically the Internet. System 200 further includes multiple data source entities 202. Each of data source entities 202 includes one or more databases 206, and one or more servers 208.

System 200 further includes multiple end user systems 210. Each end user system 210 includes a display device 212 and multiple peripheral devices 214. In an embodiment, data source entities further include a user interface/browser client 204 (UI/browser client 204) that resides on an end user system 210 after being provided by facilitator 218. Details of UI/browser client 204 are provided with reference to additional figures below. As further described below, end users make use of UI/browser client 204 via network 216 for executing the methods disclosed.

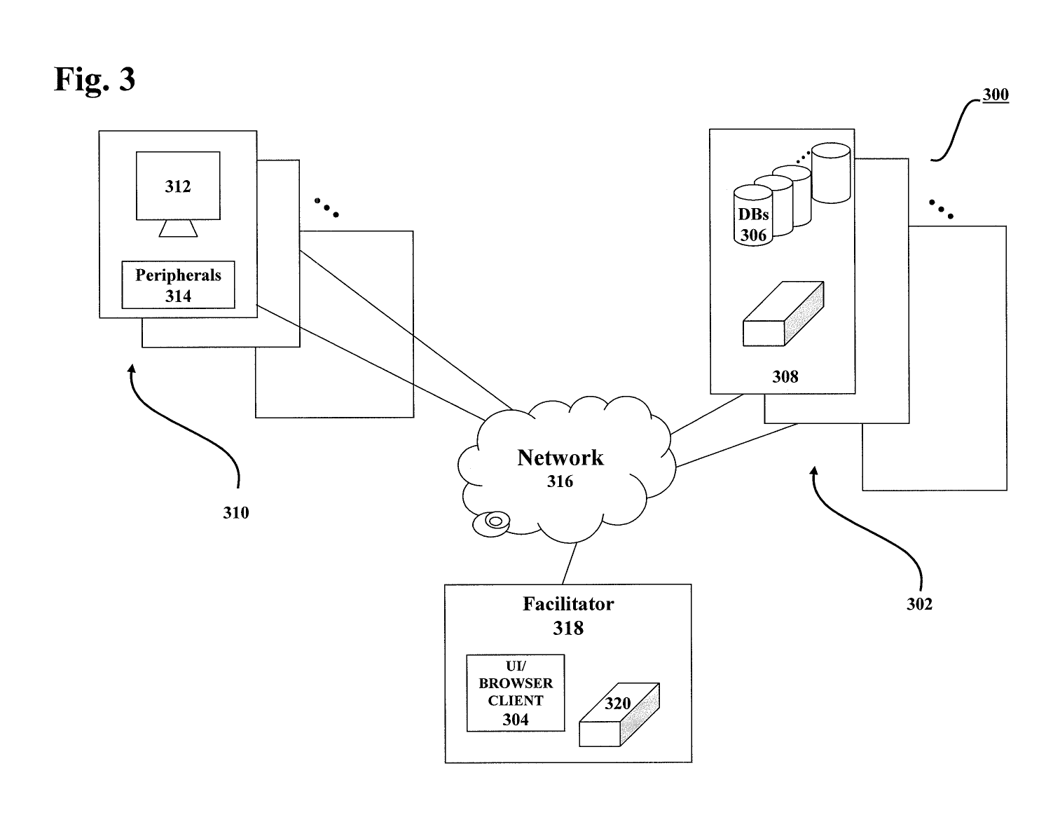

FIG. 3 is a block diagram of a system 300 according to an embodiment. System 300 includes a facilitator 318, which for purposes of this description, is hardware and software maintained by an entity on a network to provide the apparatus and method disclosed herein. Facilitator 318 includes one or more servers 320. Facilitator 318 communicates via a network 316 with any other entities on the network 316. As previously described, network 316 can be any type of local network, wide area network, or global network, but is typically the Internet. System 300 further includes multiple data source entities 302. Each of data source entities 302 includes one or more databases 306, and one or more servers 308. In an embodiment, facilitator 318 further includes a user interface/browser client 304 (UI/browser client 304) that is served on demand to end user systems 310. Details of UI/browser client 304 are provided with reference to additional figures below.

System 300 further includes multiple end user systems 310. Each end user system 310 includes a display device 312 and multiple peripheral devices 314. As further described below, end users make use of UI/browser client 304 via network 316 for executing the methods disclosed.

The UI/browser clients 104, 204 and 304 provide a user interface to the end user. The UI/browser clients handle all the data received from any servers via any connected network, intelligently convert the data, and presents the resultant information to the end user in a user-defined way. The UI/browser clients can be standalone applications directly running on top of an operating system, a script or installable plug-in module running on top of Internet browsers such as Firefox™, Internet Explorer™, etc. or an application running on top of other applications such as Adobe Flash™, Microsoft Silverlight™, etc.

Servers as shown in FIGS. 1-3 provide necessary data to the UI/browser client in interactive ways, so that the browser can convert the data and present the relevant information to the user.

The apparatus and method deal with generic objects or concepts that are capable of representation as electronic data. However, for the purposes of this description, the context of merchandise shopping is used here as an example, and hence the objects or data are described as items available for purchase. Information about an object is primarily derived from machine-understandable descriptions of the object. The description of an object could be articulated in terms of its physical features, belongings, nature, usage, etc. For example, information about a shirt could consist of its physical attributes such as its color, sleeve type (short, long, etc.), collar style, fabric material, button color, etc., as well as non-physical attributes such as whether it is dress or casual wear, its brand, manufacturer, country of origin, etc. or its usage such as men's or women's wear, winter or summer wear, etc. For simplicity, all these parameters (such as physical attributes, belongings, usage, etc.) are normalized to one term called ‘attributes’ in this document from hereon. In a typical implementation using database systems, products are stored in one or more tables with rows used for individual products and columns used for various attributes of the products with values of columns signifying values of the attributes.

When a user is able to describe an object in terms of its various attributes, the browser gathers this information, consults locally as well as with the server to derive matching objects and presents the results in a user friendly way. The user can subsequently refine or enlarge the scope of the description of the object (by adding/dropping of attributes as well as changing the bounds/scope of some attributes) and submit to the browser in the form of expressions, explained later, for further improved results. The attributes of an object could be previously known or intuitively picked from descriptions of objects presented to the user already. The attributes may be ranked among themselves based on their global relative importance (independent of their associations with any object) and/or dynamically inferred or algorithmically computed based on relative ranking among attributes of one or a collection of objects.

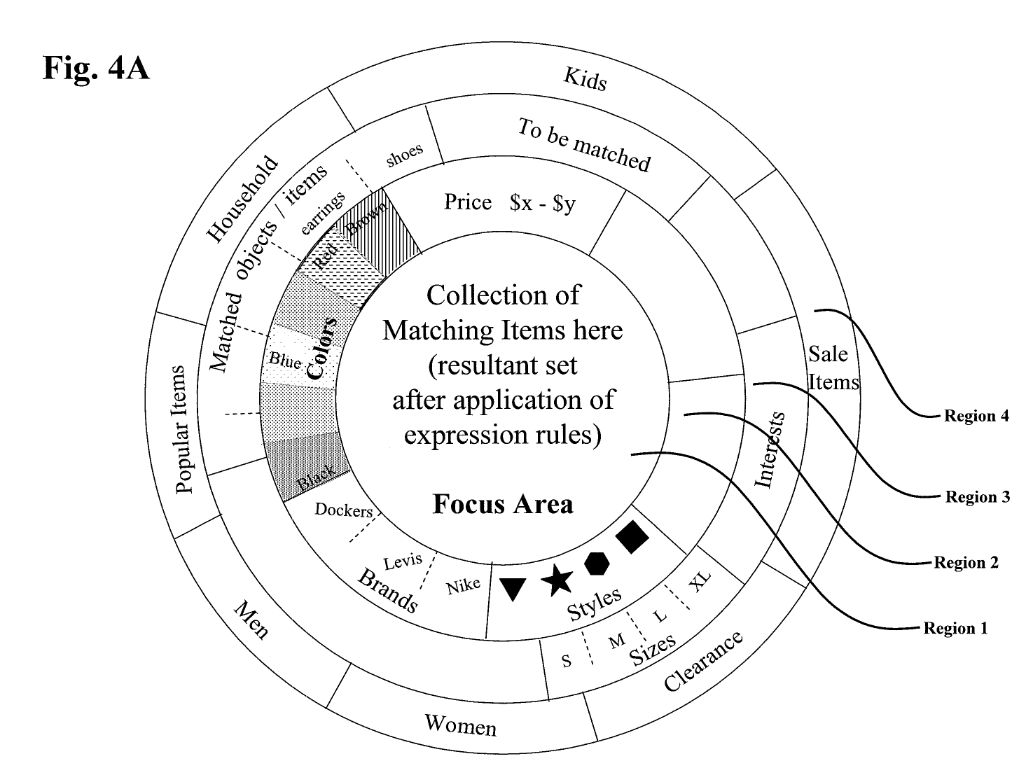

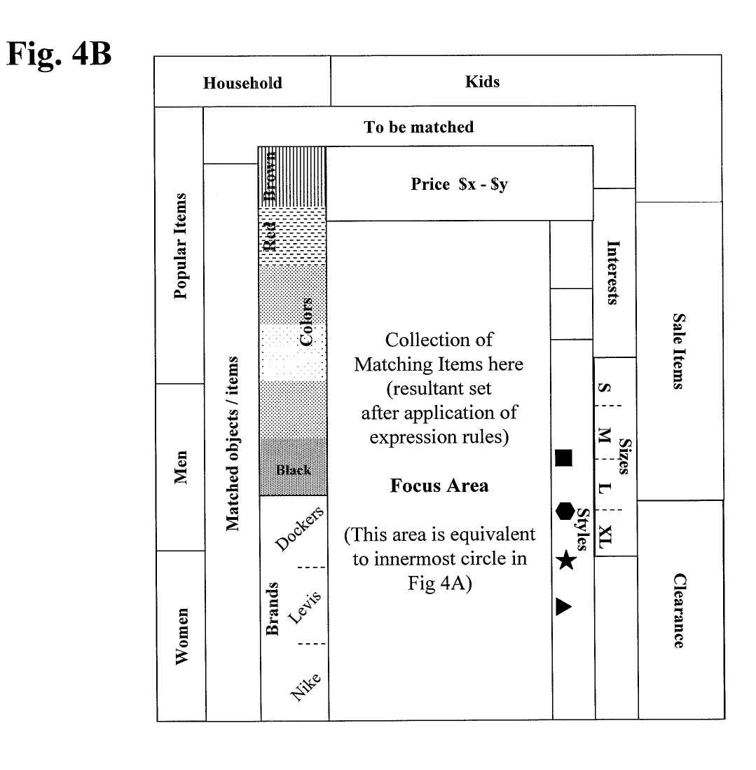

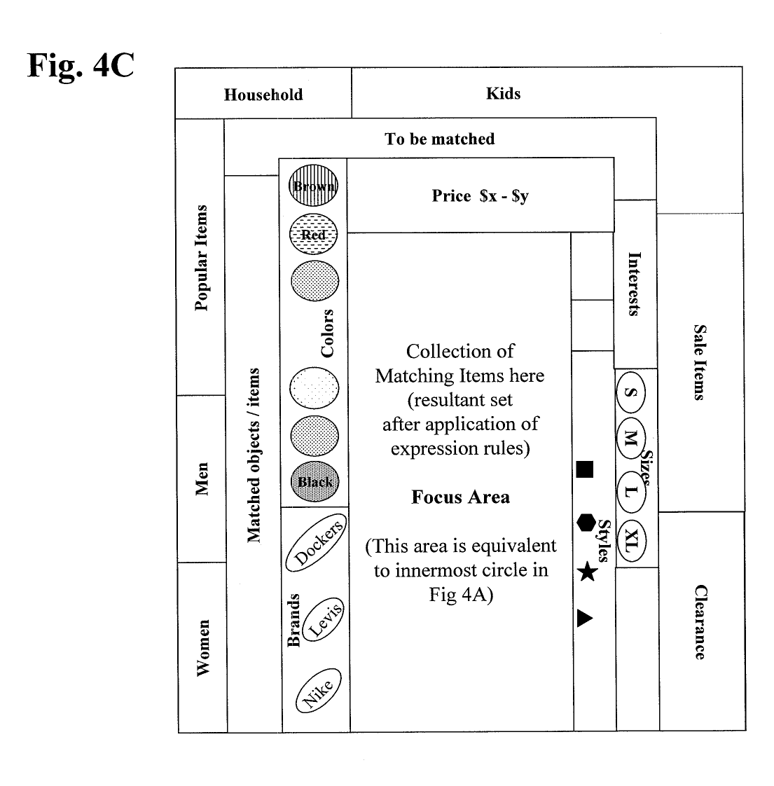

FIG. 4A is a diagram of a user interface screen according to an embodiment. The layout presented in FIG. 4A is circular, but embodiments are not so limited. Attributes are arranged as wedges in this circular presentation. However, the layout is not restricted to only circular presentation alone. Any other shape such as wedge, partial circle, partial or full ellipse, any polygon, such as square, rectangle, hexagon, etc., or partial nature of them as well can be used in place of the circle. One special advantage in circular or elliptical presentation is that it always appears continuous without any abrupt edges. For example, the attributes in the outer ring (such as Household, Kids, etc.) and attributes in the next inner rings and the all the way to the attributes in innermost ring could be arranged in a spiraling manner so that all the attributes could appear in a continuous manner without visually presenting any edges or breaks.

With continued reference to FIG. 4A, there may be any number of concentric rings containing attributes as wedges (or polygonal section or any equivalent segment of any shape considered in place of the circle) present inside the circle. Instead of multiple disjoint rings, the wedges could be arranged continuously in a spiral fashion towards the center of the circle. The wedges are arbitrary in their size in terms of their angular sweeps as well as their radial heights. The inner circle (with no further division in terms of wedges) named as “Focus Area”, is the region of focus for the user (also referred to as “inner circle”, or “central circle” in this description). This region holds the results of an object (or item) search.

The central circle, as shown in FIG. 4A, is treated to be very similar to any wedge, but is completely independent from all the wedges around it in terms of relationship (namely it is not a contained wedge, as described more fully below). Wedges (also referred to as sections) are described in detail below. The central circle is typically used as a work area to build expressions and visualize results before they are finalized. The central circle may be associated with an expression, which is influenced by any drag and drop or other similar operation on to it.

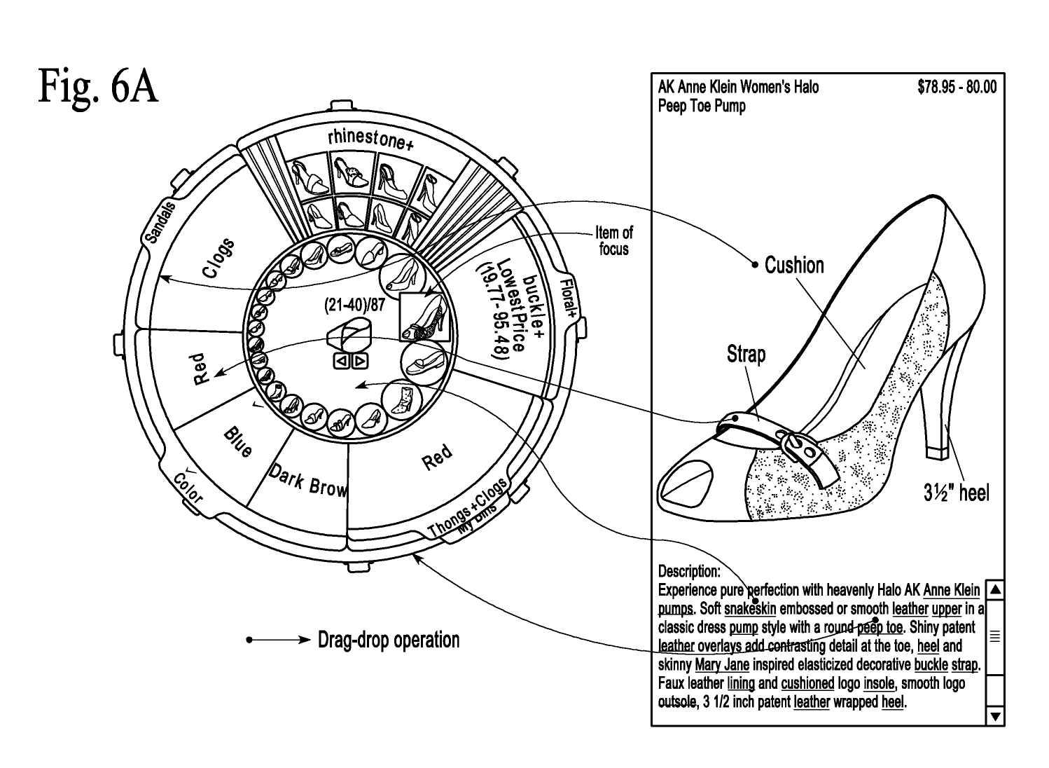

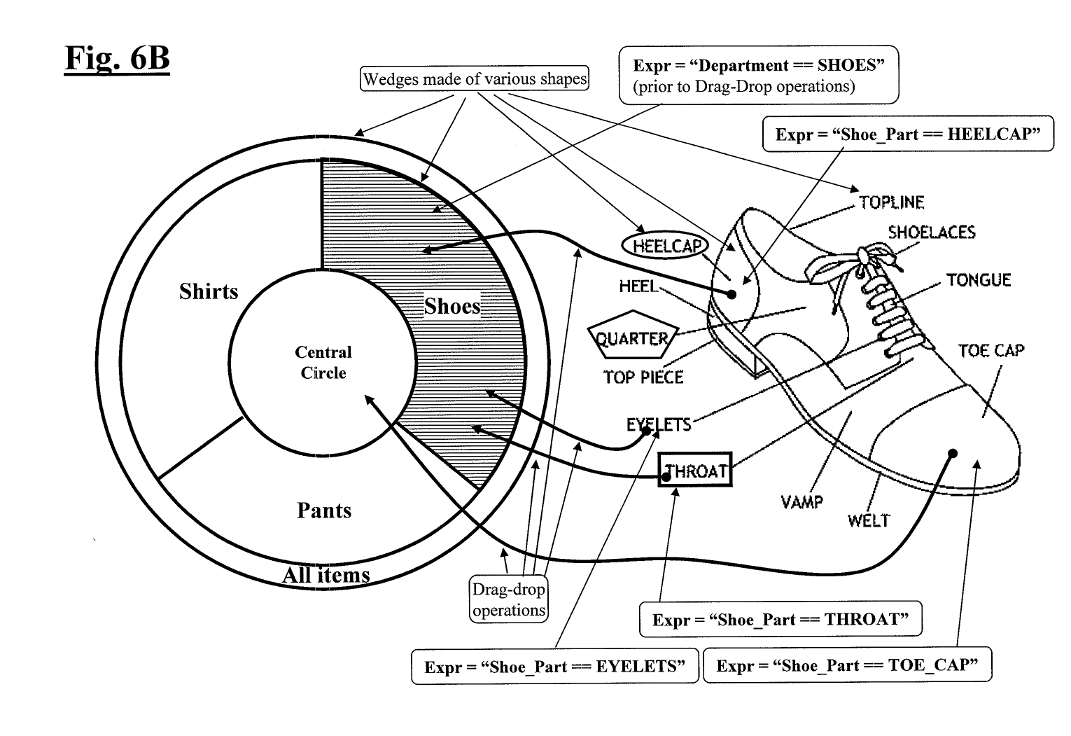

FIG. 6A is a diagram illustrating the use of the central circle according to an embodiment. The user can drag and drop items of interest, whether they be underlined (hyperlinked terms regarding an object (the illustrated shoe), or any identifiable part of the object (shoe) itself into the central circle. The central circle or focus area is primarily used as a work-in-progress area to collect items of interest to the user. The results are listed or shown as icons, or pictures of objects, but in various embodiments, results can be listed in any other way.

Although, drag and drop operation is mentioned throughout this document to associate two objects through influencing relationships (such as a dragged object and the destination object where it is dropped changing the results), any similar operation could also be used in its place such as using a menu command or shortcut keys on the keyboard, etc.

Referring again to FIG. 4A, the ring next to the central circle is referred to as Region 2, and is the next region of focus. Region 2 may contain attributes as wedges, which are very closely relevant to the objects in the innermost circle. The attributes in this region are more frequently used/applied than the ones in outer rings. Outer rings mentioned as Region (3) and (4) may hold wedges relevant to the items in the inner circle, but they are less relevant than the wedges in region (2). There are no differences between wedges in Region (2), (3) and (4), except that the wedges in outer rings are of lower interest to the user by choice, relevance or otherwise.

A wedge may optionally be subdivided either in radial, angular or both directions into multiple related containable (sub) wedges. The wedge being sub-divided is called ‘container wedge’ and the wedges within that are called ‘contained wedges’. Examples of such wedges are shown in outer rings of FIG. 4A (Sizes, Styles, Brands, etc.).

Wedges may be arbitrary in shape. Any point & click area on the screen could be defined to be a wedge. For example, a portion of a circle (e.g. the bounded region enclosing “Kids” in FIG. 4A), a circle, a rectangle, an icon, a part of or whole image, any text string in an part of the screen including a written description/title, etc. As an example of differently shaped wedges, consider FIG. 4B and FIG. 4C. FIG. 4B is equivalent to FIG. 4A using polygons for the wedges (most of them having rectangular shapes). FIG. 4C uses bean and bin shaped wedges to display the wedges shown in FIG. 4A. Note that in all these examples, wedges could be arranged next to each other or separated by gaps or with any other elements between them.

Rings or partial rings (also generically referred to as regions) can be rigidly configured using the UI/browser client (also referred to herein as the client) for specific uses (such as “Price” as a wedge to always exist in the outmost ring) or made flexible to be arranged or sized by the user. The user may choose to create, reorder, retain, delete or minimize the rings and wedges. Regions can be promoted (to be inner rings) or demoted (to be outer rings) as well. Sweep and radial height of the regions can also be controlled in rigid, arithmetic or algorithmic manner and as well as by the user based on various parameters such as aesthetics, number of wedges or objects/items it holds, etc. Similar to regions, arrangement and size of wedges can also be rigidly configured, arithmetically computed, or made flexible to be arranged or sized by the user.

Placement of attributes in wedges may be algorithmically determined. Attributes may appear or disappear based on the context of definition of objects in the inner circle. When the attributes reappear on wedges, they may not appear at the same place they appeared before.

FIG. 6B is another diagram illustrating data from which wedges can be created. Any point-and-click area on the screen can be defined to be a wedge. For example, part of the image of FIG. 6B, or the whole image of FIG. 6B can be dragged and dropped to add to a wedge. It is not necessary that the wedge area or the source data area be bounded by a border or shaded within.

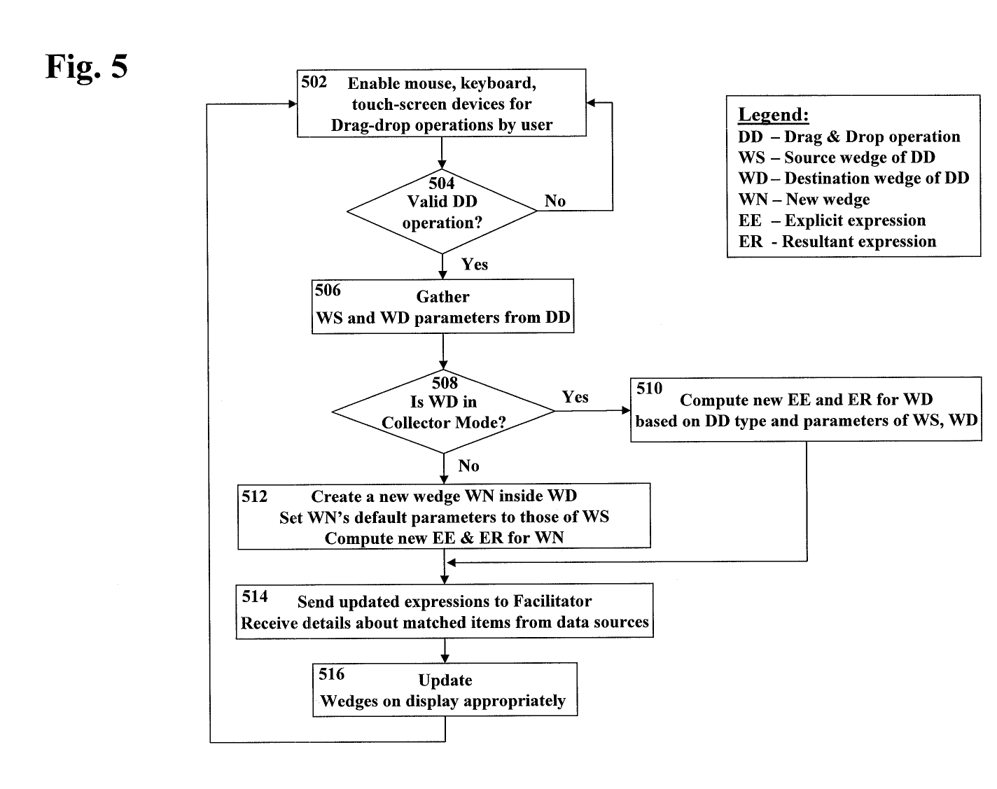

FIG. 5 illustrates a behavior of UI/Browser Client process receiving user inputs and acting on them and updating the wedges on display accordingly to an embodiment. For purposes of the description, it is assumed that at least two wedges are on display at the start of this process and the user could use any drag and drop operations to manipulate the wedges to achieve desired results. The process starts with the user completing a drag and drop operation as shown in 502. When a user completes a drag and drop operation (DD), the operation type is identified, and if the DD is recognized as a valid operation, the operation is validated in 504. If it is not a valid operation, it is ignored and the process goes back to the task at 502. If the operation is valid, the source and destination wedges (named WS and WD) of the DD operation are gathered for further processing in 506. It is assumed that a DD operation involves, as a minimum, indication of a source wedge (dragged wedge) as well as a destination wedge (dropped wedge). A wedge in an embodiment may have two modes of operations, namely “collector” and “builder” modes as discussed later in this description. If the destination wedge, WD, is in “collector” mode in 508, then its associated parameters alone are affected including its associated expressions (expressions are described later) in 510 with no new wedges created within; else, a new wedge, WN, is created inheriting parameters from the source wedge WS as well as computing its new expressions in 512. These changes in wedges along with newly computed expressions are sent to the facilitator across a network, and in turn the facilitator receives a list of matching items for those expressions in 514. At this point, processing of the DD operation is complete and the display is updated in 516 based on any new wedges to be drawn, preexisting wedges to be resized, a and resulting list of matching items to be displayed on the screen. Having completed the operation, the process goes back to 502 to receive further DD inputs from the user.

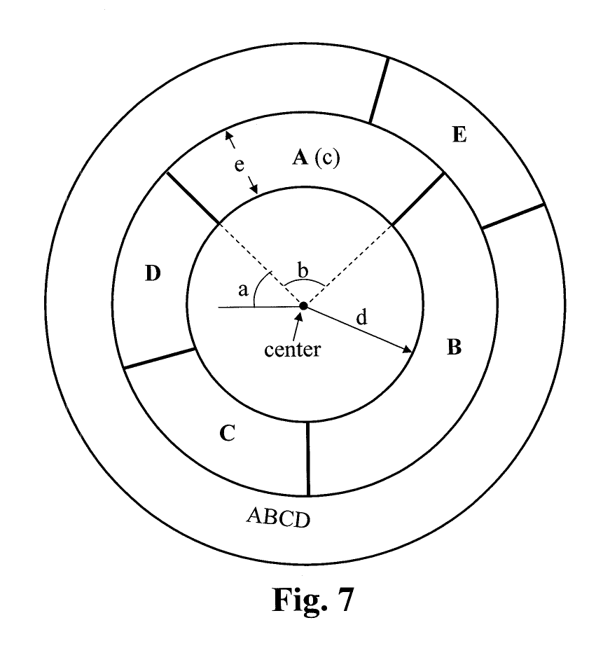

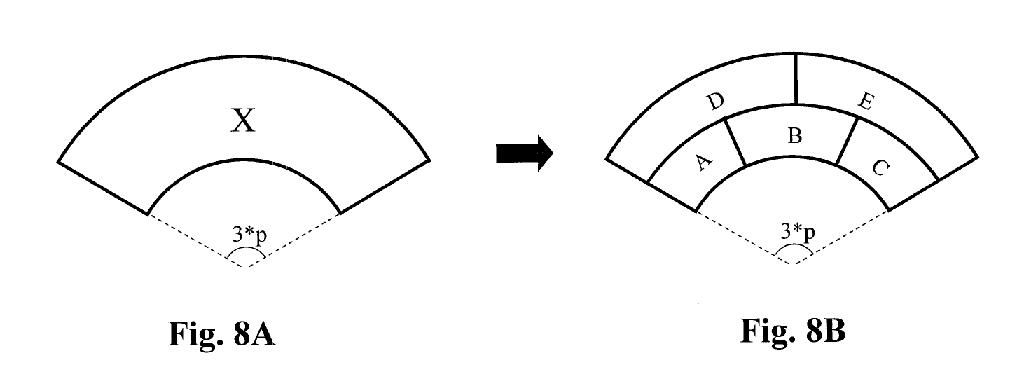

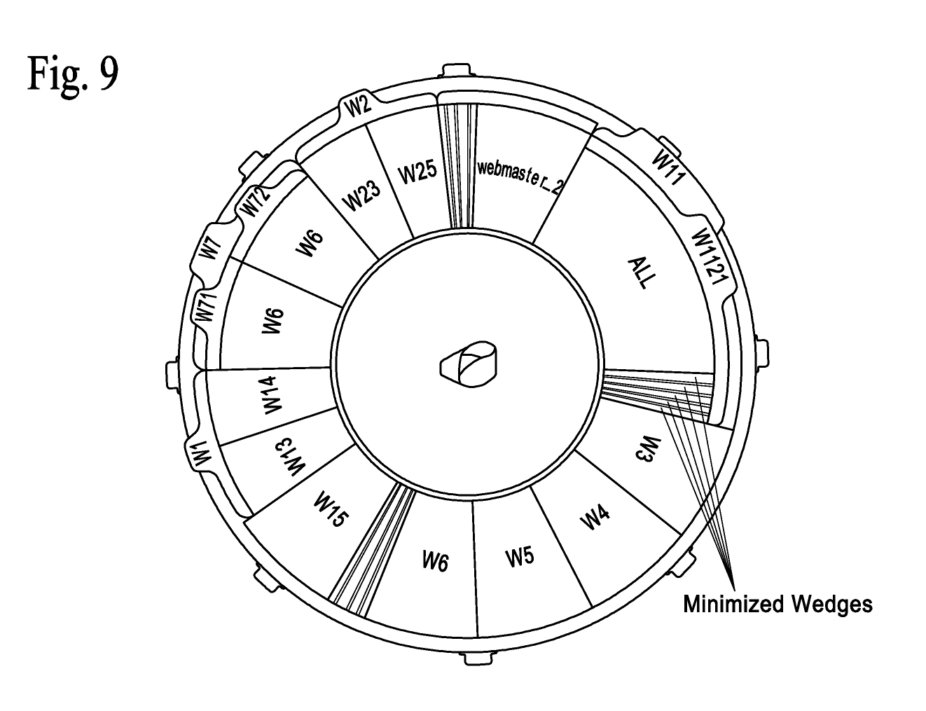

A container wedge is a wedge, which accommodates one or more wedges within its physical space. For example a full-circle container wedge ‘ABCD’ may contain wedges A, B, C and D within it as shown in the FIG. 7. In this case, A, B, C and D are known as ‘contained wedges’ of this container wedge. When contained wedges are displayed with their contained wedges shown, it is considered to be in an ‘expanded’ state. A container wedge is considered to be in a ‘collapsed’ state when it is shown as a single wedge with none of its contained wedges shown within it. As an example, wedge labeled X is a container wedge shown in collapsed state in FIG. 8A and its expanded state with its contained wedges is shown in FIG. 8B. FIGS. 8A and 8B are described in further detail below.

A full or partial circular wedge can be defined with its placement parameters as follows:

a) Starting offset ‘a’ in terms of minimum & maximum—a_min and a_max

b) Sweep length ‘b’ in terms of minimum & maximum—b_min and b_max

c) Rank among the wedges ‘c’ —either static or algorithmically computed

d) Starting radial length ‘d’ in terms of minimum & maximum—d_min and d_max

e) Radial thickness ‘e’ in terms of minimum & maximum—e_min and e_max

The units for the above could be anything meaningful. For example, units for ‘a’ or ‘b’ could be either an angle or linear length along the inner or outer circumference of the wedges and the relative starting point could be any of the X or Y-axis. Some or all of the parameters (a, b, c, d and e) can be optional. In those cases, default values can be assumed or any flexible values computed at the wedge fitting or placement time.

Considering a container wedge shown in FIG. 7 in expanded state, with a=any and b=360 as a full circle wedge, ‘b’ could be 90 for each contained wedge; ‘a’ could be ‘any’ for A, it is 90 for B, 180 for C and 270 for D if ‘c,d,e’ are assumed to be defaults.

While placing wedges within a container wedge along the angular direction, the container wedge might not have enough angular length to accommodate all its wedges. In such cases, radial length of the container wedge can be extended (though not beyond its e_max) to accommodate any remaining unfit wedges.

FIGS. 8A and 8B further illustrate wedge fitting and placement. A container wedge X contains wedges A, B, C, D and E, each of which configured with its b_min, minimum sweep length, of ‘p’ degrees in angle. If wedge X has a sweep length greater than (3*p) but less than (4*p), D and E are placed above A, B and C in radial direction as shown above. The above example assumes except for b_min, everything else are floated, and hence the remaining angle beyond 3*p to accommodate A, B and C are distributed among themselves and similarly for D and E as well. This kind of distribution of the residual length is not mandatory.

A container wedge placement and fitting method according to an embodiment is described below.

Assume a default system container wedge with default parameters for a,b,c,d,e. For example, a_min=0, a max=360, b_min=360, b_max=360, c=0, d=100, e_min=10 and e_max=1000; ‘a’ and ‘b’ are in angles.

Assume that there are ‘n’ other declared wedges which are supposed to be contained within this system wedge.
1) Sort all wedges based on:
   i. ‘d’, then
   ii. ‘a’, then
   iii. ‘c’, then
   iv. ‘b’
2) Assume d_min and e_min for the radial direction for all wedges at this point.
3) Place all wedges with ‘d’ within ‘d_min’ and given start angle ‘a’ from smallest to largest considering their a_min, a_max and b_min; b_max is not considered for this as it may force the sweep of a wedge to extend up to the beginning of the next wedge resulting in possible denying of placement of wedges with ‘a’ not given
4) There are possibilities of inconsistencies with one such case of a_min coupled with its b_min of a wedge might sweep over a_max of another wedge resulting in a constraint violation. One way to resolve such inconsistencies is to consider these wedges which are unable to be placed during step (Error! Reference source not found.
5) The above placement might create holes depending upon their individual b_max angles. If no b_min is given, assume system default.
6) The resultant holes are sorted by their sweep angles
7) After placing wedges whose start angles ‘a’ are provided, then wedges with no given ‘a’ are placed freely or flexibly within the available holes
8) These flexible wedges are sorted into a wedge-list based on ‘c’, and then by their sweep length, b_min
9) These wedges are placed within these holes, one by one as follows
10) First wedge at the top of the wedge-list is placed into the first hole which could fit it (b_min of the wedge should be less than or equal to hole's sweep length) in the hole-list, if ‘c’ is given; otherwise it is placed into the largest hole
11) Every time, a wedge is placed in a hole, the hole divided into two parts—namely the occupied wedge area and the newly created smaller hole. This newly created smaller hole is put back into the hole-list and the hole-list is sorted again, based on their starting angles, before another wedge is considered for placement
12) The process is repeated again from step (Error! Reference source not found. until all wedges are placed or no further wedges can be placed because the sweep of any hole in the hole-list is less than b_min of any wedges in the wedge-list
13) If the wedge-list is not empty in step (Error! Reference source not found., ‘d’ and ‘e’ are considered to split the circle applying e_min. A radial hole (a new ring) is created, by forcing all the placed wedges to be limited to e_min in radial direction.
14) The new ring is now considered for placement of the remaining wedges which are unable to be fit earlier, in step (Error! Reference source not found.
15) Follow step (Error! Reference source not found. onwards again until wedge-list is empty or d_max is reached in the radial direction.
16) If, at this point, wedge-list is not empty, then those wedges could not be placed at all resulting in constraint violations or too little space to fit all wedges. These wedges may be placed by forcefully breaking the constraints imposed on them by their configured values of (a,b,c,d and e) or placed as minimized wedges appropriately.
17) Now if hole-list is not empty, each hole is considered for redistribution among wedges placed before it in terms of extending their sweep lengths.
18) Redistribution of sweep of a hole is done using b_max for the wedges placed before (in terms of starting length/angle) using such methods like equally among all wedges, proportional to their b_max values, maximum for the highest of ‘c’, a combination of any of the above, etc.
19) Redistribution is repeatedly done until all holes are exhausted or no wedge could accommodate any extra sweep because of their b_max values having reached.
20) If d_max is not reached in step (Error! Reference source not found., radial hole has to be redistributed among the rings created. Radial redistribution methods could be: equally between all rings, configured uneven proportion between rings, proportionate to number of wedges in each ring, proportionate to maximum number of contained wedges in any of the wedges in each ring, proportionate to ‘c’ values of first wedges in each ring, etc.

Wedges could be drawn as minimized occupying the smallest legible size of a wedge to indicate to the user that there is a wedge available any time for expansion (to a normal sized wedge), but at the same time not taking up the size of a normal wedge. A typical scenario with minimized wedges is shown in FIG. 9.

Multiple minimized wedges could be collapsed into a single minimized wedge to save visual space when there are too many minimized wedges next to each other. As an example, in FIG. 9, the 5 minimized wedges next to each other could be collapsed into a single minimized wedge appearing as one wedge with same or different (with different color or other visual cue) visual appearance.

Wedges can have ranks. Rank of a wedge could be a fixed configured value based on the attribute associated with a wedge, or it could be dynamically assigned based on usage and relevance of other attributes during object selection process. Ordering of wedges based on rank or relevance makes a lot of difference during placement as more relevant wedges placed together would give a cue to the user as to how they could be accessed quickly or easily.

Rank of a wedge, ‘c’, is a number used in the layout of the wedge relative to other wedges. Lower the rank value higher its importance in placing it closer to the central circle. Its value is a function and it is dependent on 3 other factors as shown below:

c=fn(ra,rn,rc),

where
fn( )is an arithmetic logical function,
ra is the attribute rank and is a function of all rank values of attributes used by the wedge in its expressions
rn is the navigational rank of the wedge and
ru is the relative usage rank and is a function computed based on number of attributes which are common between the ones used by the wedge and the ones used in the central circle.

Navigational rank, rn, is a number assigned to a wedge relative to other wedges using a function based on frequency and relative time the user used or visited a wedge with respect to others. For example, whenever a wedge is visited, its navigational rank value could be reduced by a constant or by a factor. As another example, rn could be a simple function of visited time as

rn=1/vt,

where vt is time of day in number when the wedge was last visited

Usage rank, ru, is a number computed using a function based on attributes common to both the wedge's and the central circle's expressions. As an example, rc could be computed as

ru=1/n,

where n is the number of used attributes common to wedge and the central circle

Data items, in this shopping example “products”, are considered to have one or more attributes. For example ‘color’, ‘brand’ and ‘price’ are some of the attributes of life-style products; ‘keywords’, ‘category’, ‘matching-string’ are some of the attributes of web-page contents, etc.

Each attribute could have zero or more values. For example, attribute ‘brand’ for life-style products may have enumerated values such as ‘Dockers’, ‘Nike’, ‘Calvin Klein’, etc.; attribute ‘price’ may have range of values, ‘color’ may have enumerated, range of values or a combination of both, etc.

An expression is an arithmetic, conditional or logical expression well known in the field of mathematics. In the context of this disclosure, an expression involves attributes and values as parameters. For example, “(brand==‘Nike’ && Color==‘Blue’)” is a valid expression. Expressions could be more complex, such as the following:
_(Department==‘Men” &&
   (Category==‘Shirt’∥Category==‘Pant’) &&
   (Price>10 && Price<100))∥
(Department==‘Women’ &&
   (Category==‘Skirt’∥Category==‘Shoes’) &&
   !(Price>150))

Operator ‘==’ means ‘equal to’, ‘>’ means ‘greater than’, ‘<’ means ‘less than’, ‘&&’ means ‘and’, ‘∥’ means ‘or and ‘!’ means negation of the condition.

An expression may involve database operators also. In any structured query language (SQL) supported database, invoking operations using SQL command set is well known in the industry. Although an expression in an embodiment using SQL database operators is shown below as an example, it is not limited to this type of database operators alone.

‘select products from product_table where
color==red && heel_height (shoe_size*2/3);’
   here, database operators ‘select’ and ‘where’ are used to select column values of ‘products’ of specific set of rows of a table named ‘product_table’, matching the condition of “color ==red && heel_height (shoe_size*2/3)”. The variables ‘color’, ‘red’, ‘heel_height’ and ‘ shoe_size’ could be constants, attributes or column values of rows in consideration.

Any wedge may be statically or dynamically assigned with an expression. Unlike in typical web pages, where a button or wedge like UI element is associated with a label, static or derived URL or command used to invoke further actions, wedges can be assigned with an expression such as cited above. This explicit assignment is absolute only in the context of the wedge considered in isolation.

Relationships between wedges play a role in forming combined overall expressions. If two wedges were assigned a relationship of “operation” between them, then the combined overall expression would be an expression containing explicitly assigned expressions of the two wedges with an “operation” operator between them.

For example, if Expr(A) the expression of wedge A and Expr(B) is the expression of wedge B and if the relationship between them is “∥” (logical OR), then their combined expression is

Combined Expression=Expr(A)∥Expr(B)

Applying this to real-world scenario, if wedge A has expression of “(Department==‘Men’)” and wedge B has “Department==‘Women’)” then

Combined Expression=((Department==‘Men’)∥(Department ‘Women’))

Physical arrangement of wedges plays an implicit relationship between them. For example, a container and one or any of its contained wedges may have an implicit or configured relationship between them. Similarly, the relationship between two wedges located within the same container may have an implicit or configured relationship between them. In one embodiment, the relationship is defined in terms of operators. For example, a container wedge and its contained wedge could be configured with an AND (“&&”) operator as the relationship between them. The configuration could be explicitly done for each container and contained wedges or it could be implicitly derived from a global configuration or statically defined a priori. Similarly, relationship between contained wedges belonging to the same container wedge could be implicitly derived to be an OR (“∥”). These are only examples. The apparatus could use any kind of operations including scientific, arithmetic, conditional and logical. The resultant expression of a wedge is the expression derived through its placement among other wedges. For example, if a wedge is located inside a container wedge, the resultant expression is the combined expression of its explicitly assigned expression and the container's resultant expression using their relationship operator between them. As a specific example, if a container wedge ‘A’ contains a wedge B within it and if ‘A’ and ‘B’ have explicitly assigned expressions of “(Department==‘Men’)” and “(Brand==‘Nike’)” respectively and if the container's resultant expression is same as its explicitly assigned expression (namely it is not contained within another wedge which has a resultant expression) and the relationship operator between a container and contained wedges is configured to be “&&”, then B′s resultant expression is

“((Department==‘Men’) && (Brand==‘Nike’))”

In various embodiments, the appearance of wedges has significance. Coloring of wedges may signify a relationship between wedges; if wedges are colored with same base color, they appear as a group, but at the same time distinguishable from other unrelated wedges. In an embodiment, the method to choose a color is as follows:

1) A wedge has following coloring related parameters
a. Fill color—‘fc’
b. Containing wedges' base color—‘bc’
c. Blend ratio—‘br’—possible a fraction between 0 and 1
d. Blend Fraction increment—‘bf’
   2) Fill the wedge with color ‘fc’.
   3) For all its contained Wedges 1 to n with index do the following
a. Compute fill-color ‘fc’ as a ratio of base color ‘bc’ as

Wedge(i)fc=((1−br)*fc)+(br*bc))

fc=fc+(bf*bc);

Initial ‘fc’, ‘bc’ and ‘br’ could be either derived from its container wedge (as indicated in the algorithm), or could be reset with a random color value, or an assigned configured value for the wedge before the algorithm is applied. ‘bf’ is typically calculated based on maximum number of wedges contained in the container wedge.

Any wedge could be assigned with a specific configured color. For example the ‘universe’ wedge (the all-enclosing full-circle wedge) may be assigned a configured or random color. This color is used as the fill color for the universe wedge. A base color, completely different from the fill color could be assigned to this universe wedge. Then as and when any contained wedges (of this universe wedge) are to be displayed they are assigned a fill color of a blended version of the container color and the base color with a blend ratio applied. If the entire range of blend is fully utilized, then the last wedge displayed under the container wedge would have the base color of the contained wedge.

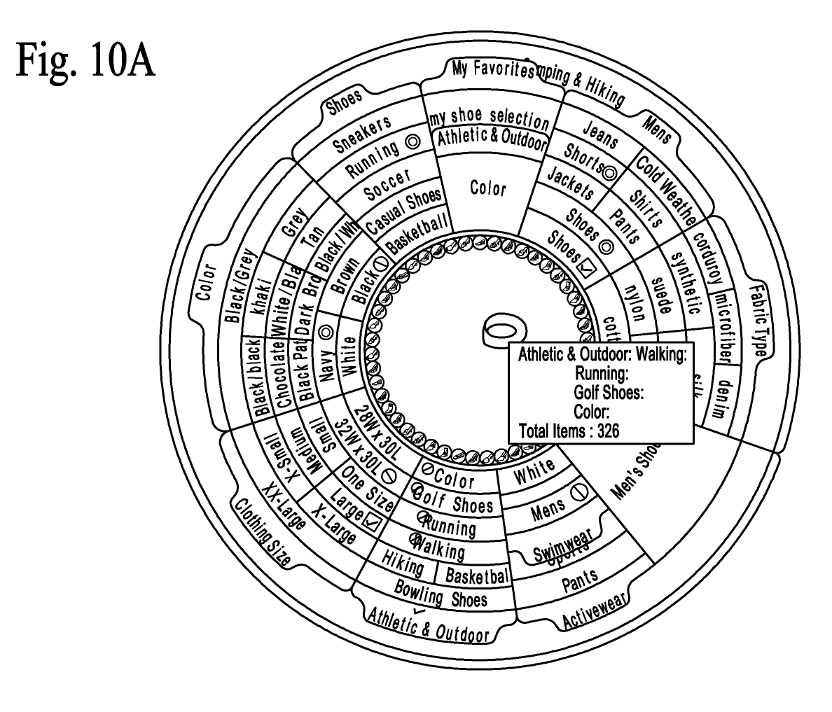

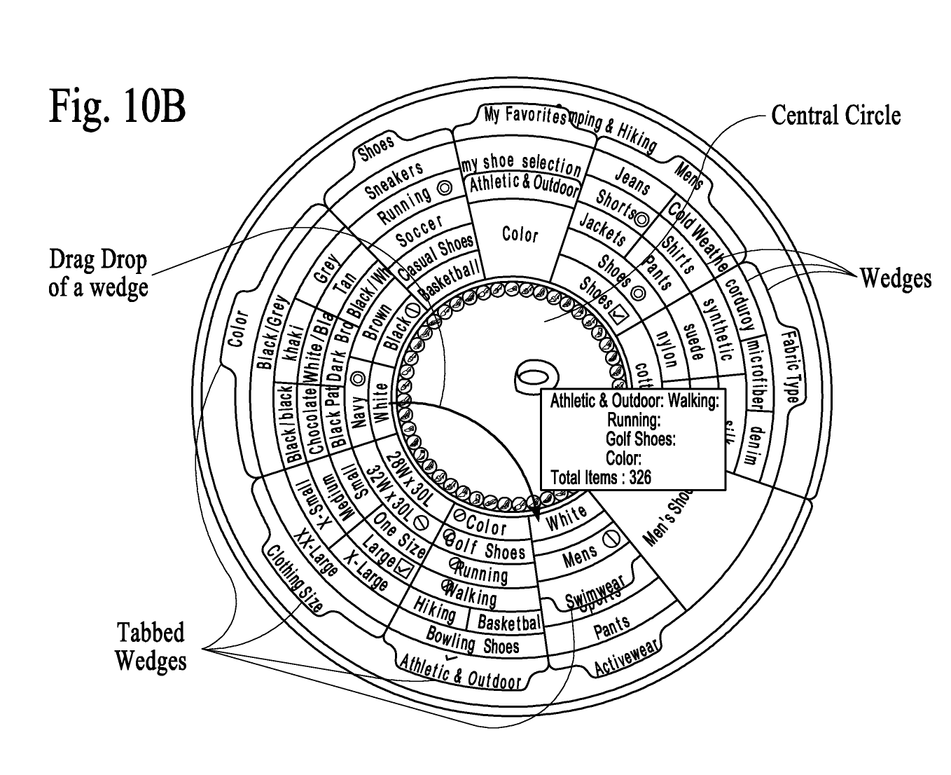

Example screenshots of the user interface with a number of wedges placed and colored using above algorithms is shown in FIGS. 10A and 10B.

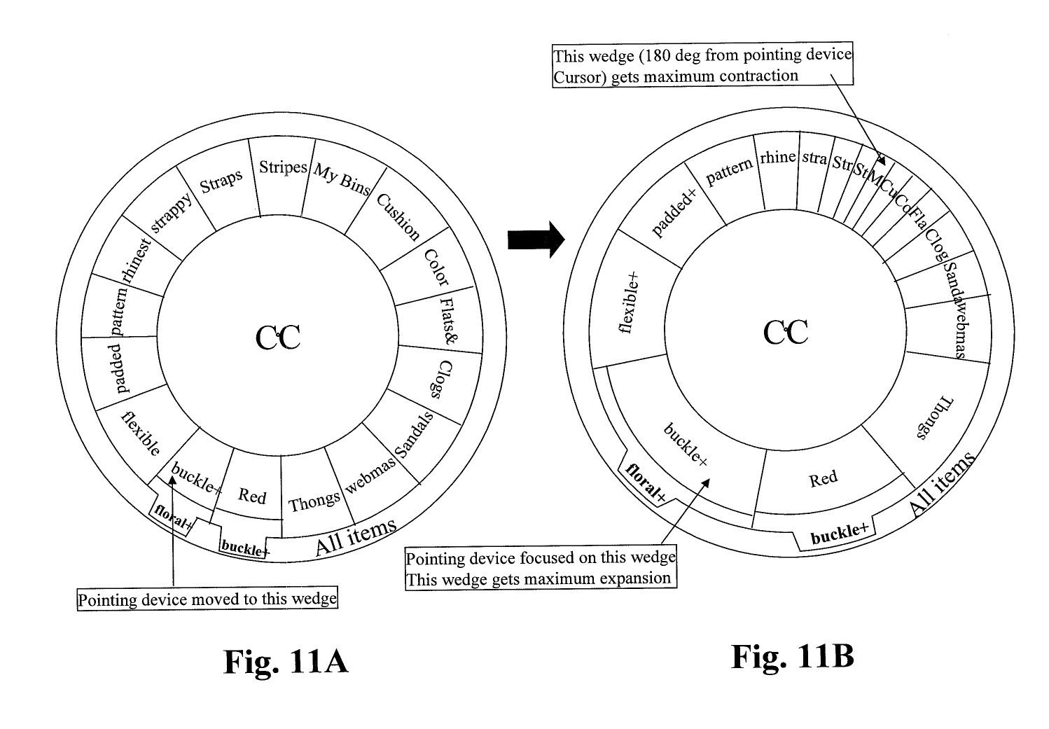

FIGS. 11A and 11B are diagrams illustrating a fish-eye technique of showing further detail of a focus wedge. A focus wedge is a wedge the computer mouse or similar pointing or selection device is currently indicating. Whenever a pointing device like mouse is hovered over a wedge, that wedge is brought to focus. Optionally, and entire area or border of a focus-wedge may be colored (highlighted) differently to make it look different from other wedges. In addition, a focus wedge and surrounding wedges can be expanded in appearance (zoomed or fish-eyed) and some or all of its surrounding wedges may be expanded or contracted accordingly to emphasize the area of focus and bring in more detailed information within the focus-wedge and visually adjust the information within the circular area. This type of fish-eyeing (zooming and contracting) of wedges can be either in angular, radial or in both directions and the entire (enclosing) circular area may or may not expand or contract during this operation.

Referring to FIGS. 11A and 11B, when the focus is brought to a wedge labeled “buckle+” under “floral+” in FIG. 11A, it is transformed to the image of FIG. 11B with “buckle+” fish-eyed with maximum expansion, while the neighboring wedges are expanded relatively less and the wedge labeled “Cushion” (which is furthest away from the focus) is most contracted wedge.

A wedge may be drawn as one with a tab on it (as shown in FIG. 10B for example). This is useful where more information needs to be presented within a wedge. As an example, container wedges could be shown as tabbed ones, as the container wedge should display all its contained wedges within it. Such tabbed wedges can still have enough area allocated to it then accommodate its contents (e.g., its contained wedges). Another example of a tabbed wedge is a non-container wedge, which shows all its properties within its area such as number of matching products, its operator icons, etc.

Wedges themselves can be considered to present information related to the wedge. Wedges can be used to hold an expression (as explained earlier), and it can be useful to see the effects of the expressions right in the wedge itself. When multiple wedges display similar effects, such wedges can be compared by looking at the information presented within each of these.

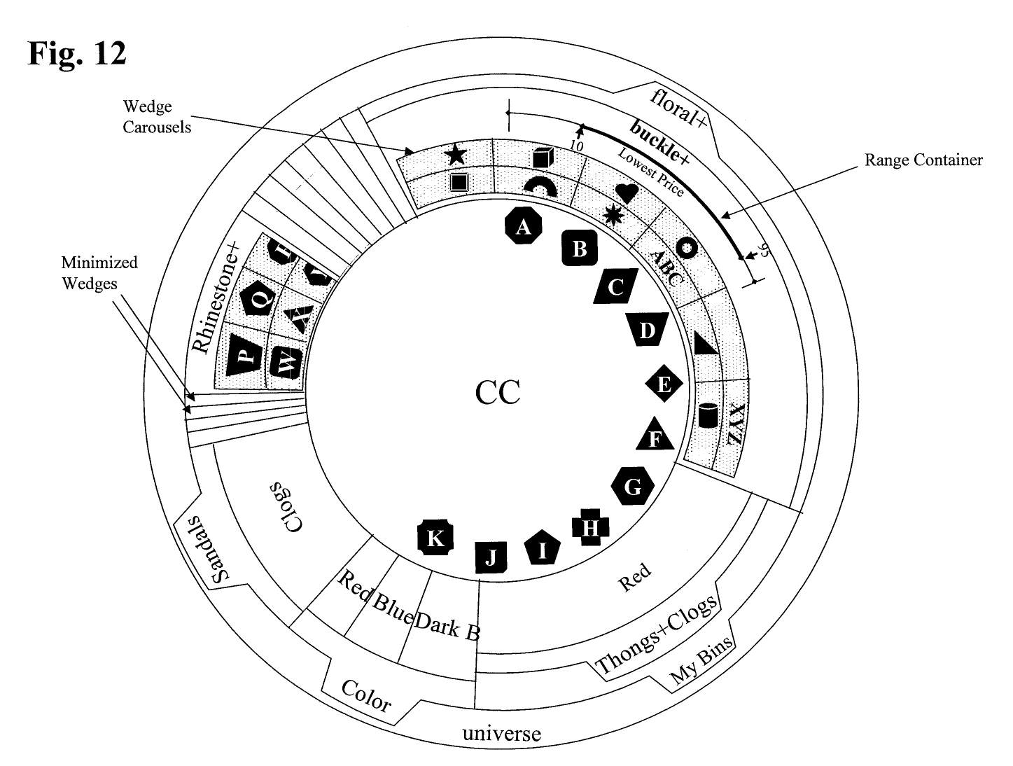

Another type of wedge or wedge effect is referred to as carousel. Matching items (such as list of products satisfying the resultant expression) of a wedge or other enumerated list of information can be displayed as a scrollable carousel within the wedge as shown in FIG. 12. The information to be presented as one or more such carousels within a wedge is configurable. For example, two carousels can be configured with one showing matching items satisfying the explicitly assigned expression and another showing the items satisfying the resultant expression of the wedge. The association of information to the carousel could be completely arbitrary. One such example, in a life-style products scenario, is to show all products that are on sale belonging to a particular category in that category's wedge. Or even more arbitrarily, brand advertisers who want to display their brand logos in a particular wedge could be in a carousel of that wedge. An example of carousel inside a wedge is shown in FIG. 12. The list of products is shown in a curved manner in a scrollable carousel inside the wedge labeled “rhinestone+”.

Another wedge effect is referred to as range-container. A range container is a graphical user interface to express a range of numbers or items. For example ‘price’ of products could be shown as a range container. On the other hand, enumerated values such as ‘Extra-Small’, ‘Small’, ‘Medium’, ‘Large’ and ‘Extra Large’ could also be represented in a range container as well. A typical range container is shown in FIG. 12 along with carousel inside a wedge. These range containers are not just for displaying status. They are interactive and used by the user to set ranges to filter products within the set range.

For example, a range container can be set by the user in a wedge, say ‘Shoes’ whose expression is “Department==Shoes', and a rangeable attribute, say ‘Price’, is assigned to the range container. When a minimum and maximum bounds of the range is set by the user in this wedge, the explicitly assigned expression for the ‘Shoes’ wedge would become

“(Department==‘Shoes’&& Price>=MIN && Price<=MAX)”

where MIN and MAX are the minimum and maximum values set in the range container and the operator && between them is implicitly configured.

The central circle, as shown in FIG. 4A, is treated to be very similarly to any wedge, but is completely independent from all the wedges around it in terms of relationship. The central circle is typically used as a work area to build expressions and visualize results before they are finalized. The central circle may be associated with an expression which is influenced by any drag and drop operation on to it.

There are two modes of visual behavior for any wedge: builder mode and collector mode. A wedge could be in “builder” mode, in which when another wedge is dragged and dropped onto it, it would create a new wedge within it. If the wedge is not already a container wedge, it would make it to be one On the other hand, when a wedge is in “collector” mode, any wedge is dragged and dropped onto it, would only override its assigned explicit expression and will not result in creation of any new wedges within it. A user would be able to change the mode of wedges through menu operation or through configuration. As an example, the central circle is a wedge in “collector” mode by default, wherein, any drag-drop operation into it would only affect its expression and no new wedges would be created, whereas its surrounding wedges would be in “builder” mode by default.

Wedges represent relationships involving attributes and values, and also relationship amongst themselves and other wedges. Placement of wedges within another wedge, or next to other wedges, provides intuitive visual cue of relationship of belonging or peer relationships.

Various manners of wedge creation are possible according to embodiments. An empty wedge can be created through a menu or hot-key operation and placed anywhere inside or beside another wedge. An expression can be assigned in addition to creation of wedge using selection through a simple menu of pre-defined expressions such as lists of ‘Brands’, ‘Colors’, ‘Departments’, etc., where choosing a brand, say ‘Nike’, might implicitly mean an expression of “(Brand ‘Nike’)” assigned to the wedge.

Although a wedge may be assigned with an expression, it need not always be. A wedge with no assigned expression may implicitly derive its resultant expression through its relationship with others. For example, a container wedge with no explicit assignment of expression, may have a relationship of ‘Accumulate OR’ (“Σ”) operator between all its contained wedges and itself, resulting in an expression consisting of all the resultant expressions of its contained wedges with ‘OR’ operators between them.

When a new wedge is created under another (container) wedge from scratch using simple expressions (such as “(Brand==Nike)”), it can be useful to provide context specific helper list (such as a list containing only the attributes and values shared among the items of that container wedge). Otherwise, if an attribute is chosen (for the new wedge), which is not appropriate for the context (such as shared attributes of any of the items belonging to the resultant expression of the container wedge, if the relationship between the container wedge and the new wedge is an ‘AND’ (“&&”)), then the result may be empty when this new wedge is used subsequently (because of being out of context). As an example, if the relationship operator between a container wedge and its contained wedges is ‘AND’ (“&&”), the container wedge's resultant expression is “(Department==‘Shoes”)” and if the new contained wedge is explicitly assigned an expression of “(Hip_Size==‘Large’), then the result may be empty if none of the shoes have the attribute ‘Hip_Size’. Hence it is useful to prune those ‘out of context’ expressions from the helper list when a new wedge is created from scratch.

Creating such a context specific helper list involves gathering of all unique attributes of the items from the resultant expression of the container wedge, while taking the context of relationship between it and the new wedge into account.

A new wedge can also be created at a particular place by dragging another existing wedge located elsewhere and dropping it in the intended place. As an example, referring to FIG. 10B, a wedge labeled ‘White’ under a container wedge ‘Swimwear’ was created by dragging and dropping a same labeled wedge located under a container wedge named ‘Color’. Although a wedge created during this operation may derive some or all of its properties (such as label, explicitly assigned expression, color, relationship operator, etc.) from the dragged wedge, those properties could be overridden using other default or configured values. Note that for such wedge creation, the wedge, which is receiving the drag and drop operation, should be in “builder” mode.

Although the central circle behaves just like any other wedge, as mentioned earlier, with no implicit relationship/association with other (surrounding) wedges, behavior for operations such as ‘drag & drop’ typically has different significance for the central circle. As an example, dragging and dropping a wedge onto the central circle can imply ‘Accumulate OR’ or ‘Accumulate AND’ operation (“Σ”) as opposed to creation of a wedge inside it.

Like any wedge, the central circle can be dragged and dropped anywhere to create a new wedge which may have its explicitly assigned expression derived from the resultant expression of the central circle.

A Wedge can be deleted either through a menu operation, hot-key operation or dragging it outside of the circular interface and dropping it elsewhere (such as an empty area or an explicitly designated recycle bin).

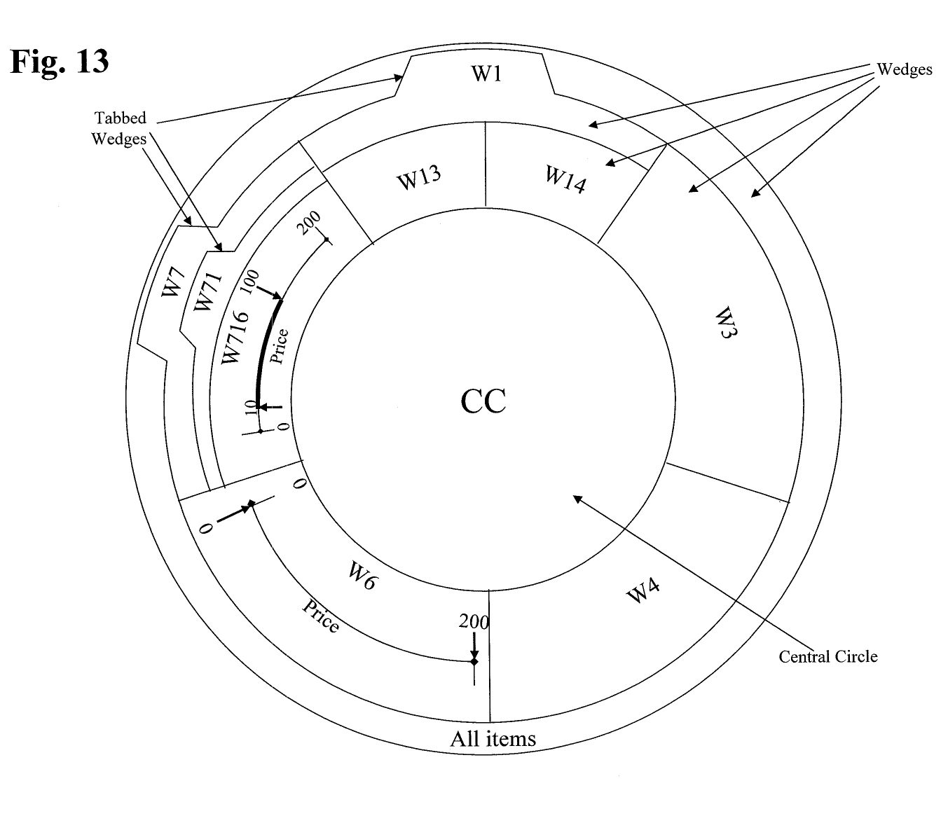

With reference to FIG. 13, complex expressions, can be created easily using the above explained navigation methods. For example, consider the following expression:

(Department==‘Men’&&
(Category==‘Shirt’∥Category==‘Pant’) &&
(Price>=10 && Price<=100))

Assume that implicit relationship between container and its contained wedges is ‘AND’ (“&&”) and the relationship between contained wedges located within the same container is ‘OR’ (“∥”). Also assume that a wedge created using a Drag&Drop operation inherits its explicitly assigned expression from its dragged wedge. Also assume that Central Circle uses “Accumulate OR’ as operation for any wedge drag-and-dropped onto it.

Each of the steps involved in creating the wedge arrangement is shown in FIGS. 17A and 17B. The process starts with a wedge ‘All items’ representing all items under consideration.

Step 1a-d: Wedges are created from scratch at the top level for each of:

W1) Department==‘Men’

W3) Category==‘Shirt’

W4) Category==‘Pant’

W6) Price==Any (with a range container having bounds from 0 to 200)

Step 2: Create another empty wedge, (preferably labeled ‘My Shelves’), with no explicitly assigned expression as

W7) “Any”

Step 3a,b: Drag and drop wedges to create sub expressions using implicit relationships of && between them:

W13) Created through Drag&Drop of W3 onto W1

W14) Created through Drag&Drop of W4 onto W1

At this point, following resultant expressions are available at:

W13: (Department==‘Men’ && Category==‘Shirt’)

W14: (Department==‘Men’ && Category==Pane)

Step 4a,b: Drag and drop wedges W13 and W14 onto Central Circle (CC). This will create a resultant expression for CC as “(W13∥W14)”, which when expanded is equivalent to:

(Department==‘Men’ && Category==‘Shirt’)∥

(Department==‘Men’ && Category==‘Pant’)

which is the same (through Boolean reduction) as

(Department==‘Men’ && (Category==‘Shirt’∥Category==‘Pant’))

Step 5: Drag and drop the CC onto W7 to create a new wedge W71 underneath it. W71 would have an explicitly assigned expression of:

(Department==‘Men’ && (Category==‘Shirt’∥Category==‘Pant’))

after the operation through implicit derivation.
Step 6: Clear all (built up) expressions in CC through a menu operation.
Step 7: Drag and drop W6 onto W71 to create W716.
Step 8: Set the range container lower and upper bounds of W716 to be at 10 and 100 respectively. At this point, we have its resultant expression as
W716: (Department==‘Men’ &&
   (Category==∥Category==‘Pant’) &&
   (Price >=10 && Price <=100))
At this point, the wedge creation is completed and the resulting arrangement is identical to the one shown in FIG. 13.

Step 9: At this point, if W716 is dragged and dropped onto CC, then CC may display all products satisfying the intended expression of:
(Department==‘Men’ &&
   (Category==‘Shirt’∥Category==‘Pant’) &&
   (Price >=10 && Price <=100))

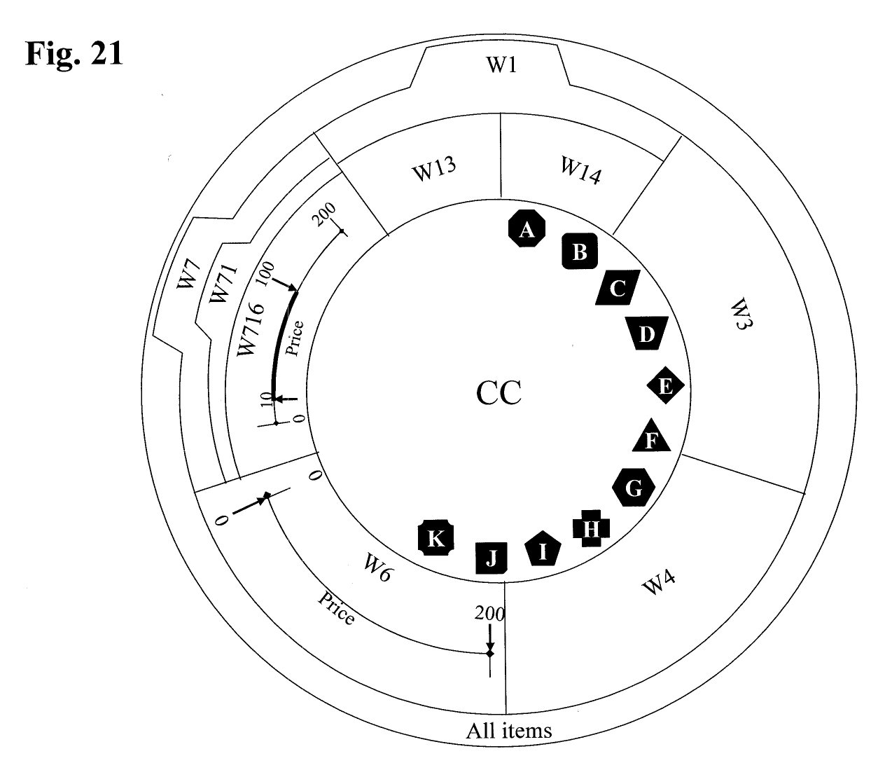

FIG. 21 is a diagram illustrating the wedge arrangement representing the foregoing expression. FIG. 21 is a diagram similar to FIG. 13, except that FIG. 21 also shows selected items in the central circle

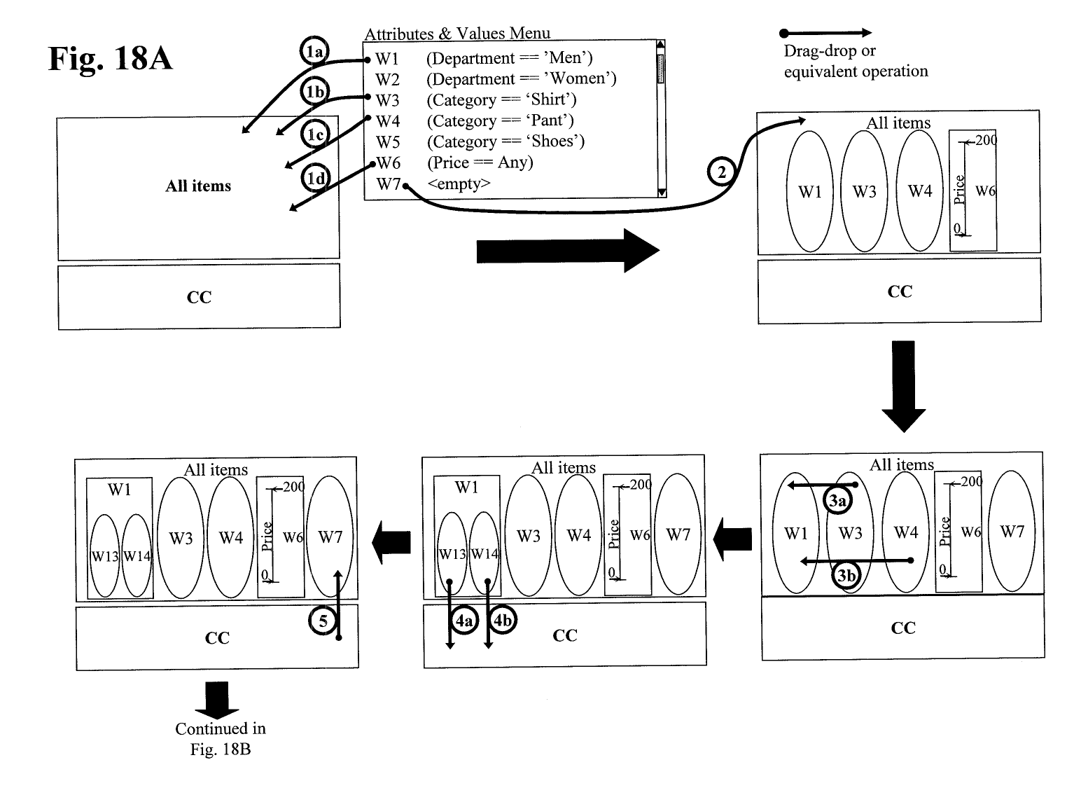

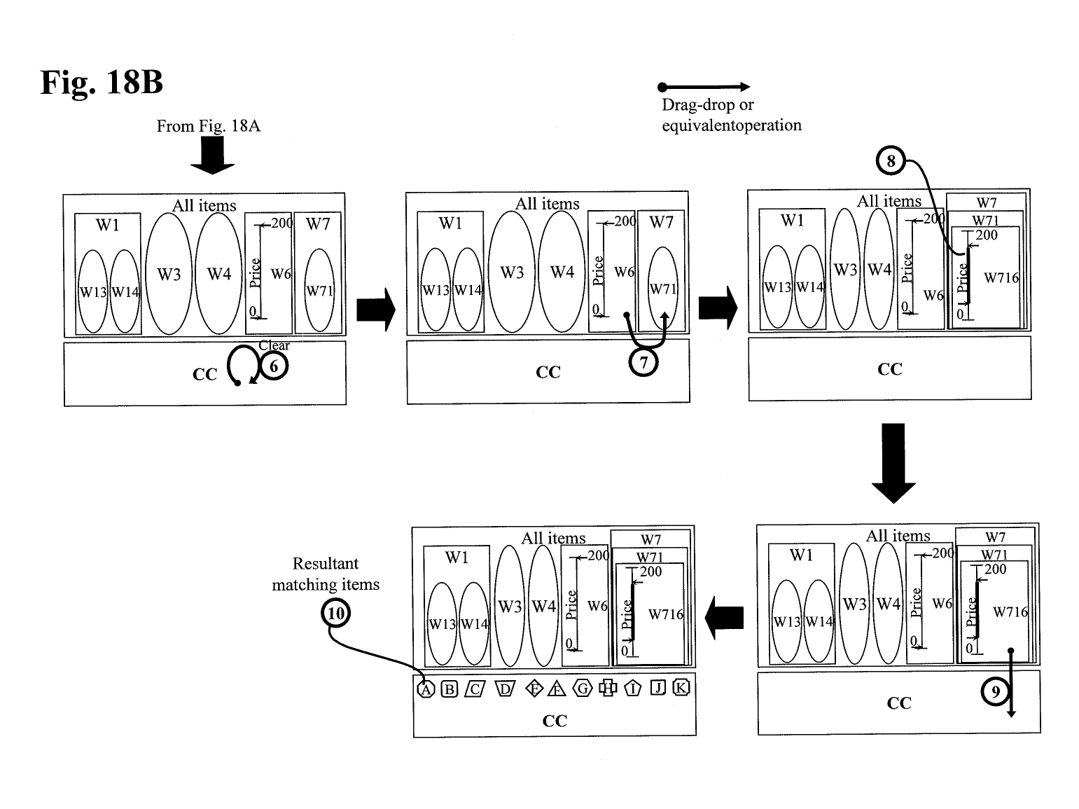

An illustration of how the above steps could be identically accomplished using oval and rectangular wedges, known as bean and bin shaped wedges, in place of partial circular wedges, is shown in FIG. 18A and FIG. 18B.

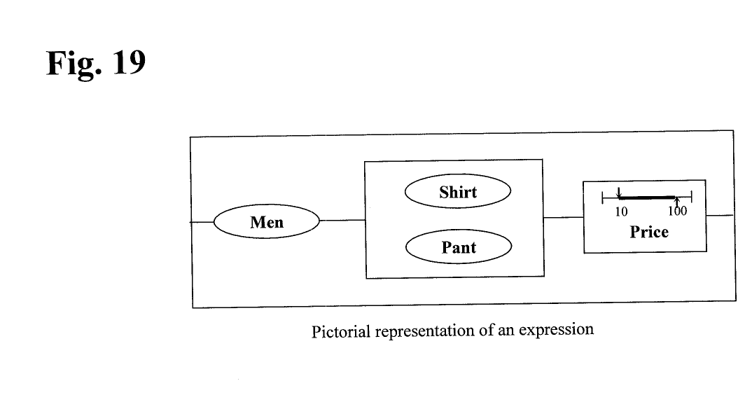

Any expression can be pictorially described using the previously described wedge arrangements very clearly. As an example, the above expression
(Department==‘Men’ &&
   (Category==‘Shirt’∥Category==‘Pant’) &&
   (Price>=10 && Price <=100))
      is pictorially represented using bean and bin shaped wedges as shown in FIG. 19. Here, “Department==‘Men’”, “Category==‘Shirt’, “Category==‘Pant’” and “Price>=10 && Price<=100” are shown in a bean named ‘Men’, a bean named ‘Shirt’, a bean named ‘Pant’ and a bin named ‘Price’. The left to right placement of these bean and bin wedges next to each other signifies the “&&” (logical AND) operator between them and the placement of beans within a bin signifies the “∥” (logical OR) operator between them. Connecting lines are optionally used here to emphasize the relationships.

Creation of a new wedge with a resultant expression is equivalent to creation of a new attribute or a value. For example, dragging and dropping existing colors from “Colors” wedge into “Winter Colors” is equivalent to creating newer values for the attribute ‘Winter Colors’. Another example is the wedge W716 in FIG. 21 can be designated as a new attribute and submitted back to the server/facilitator to be shared for future attribute use. Thereafter, W716 is available as an attribute whose matching products are the matching products of

(Department==‘Men’ &&
(Category==‘Shirt’∥Category==‘Pant’) &&
(Price>=10 && Price<=100))

Even broadly, a new container wedge with one or more new contained wedges with resultant expressions is a good candidate for a new attribute (container wedge contributing as a new attribute) with new set of enumerable values (contained wedge contributing as values) for the attribute. This creation can be submitted back to the apparatus through a menu command for preservation and reuse during subsequent sessions.

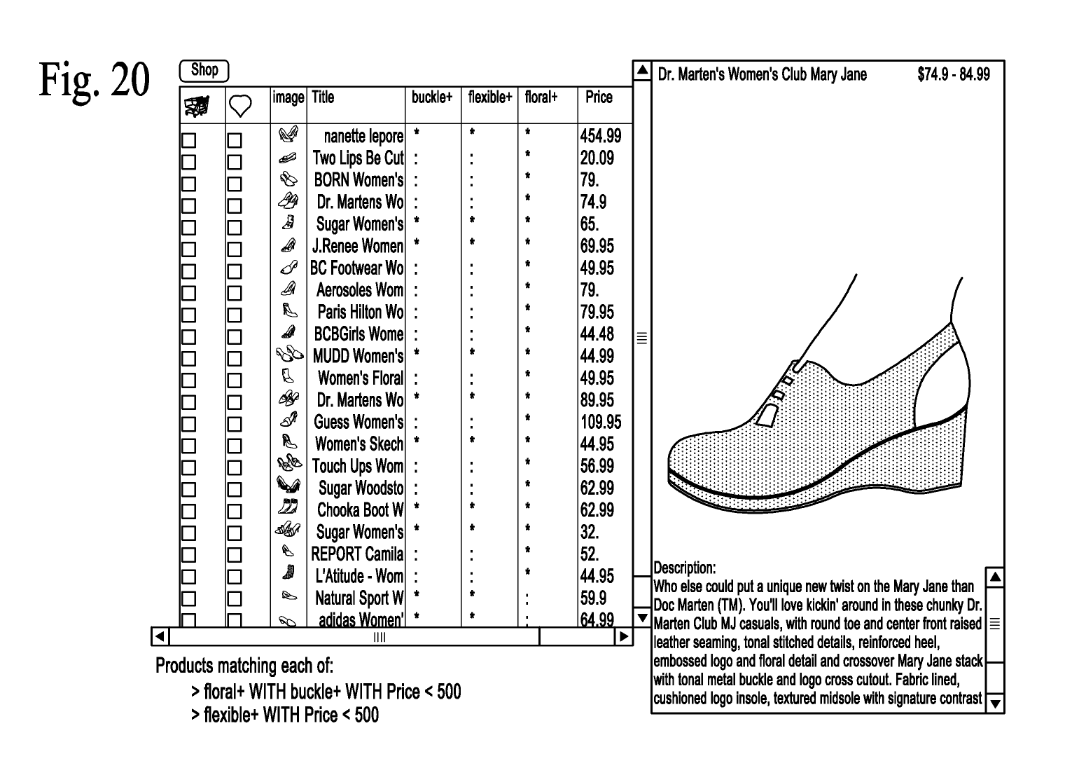

A tabular view of matching item can also be achieved in various embodiments. This provides a comparative view of the matching products. Although the central circle displays the matching items satisfying the resultant expression in terms of graphical objects such as icons or item names or their identifiers, it can be made even easier in some cases to visualize comparative data between the items in the central circle. A tabular view of the details of the matching products is then very useful in comparing the items in terms of the variation of their attributes and values. Embodiments provide a tabular view by intelligently including appropriate attributes as columns for easy comparison. As an example, a tabular view of the items matching the expression previously discussed with reference to the expression built during Step 9 in FIG. 17B is shown in FIG. 20. As one can see, this list has columns for relevant attributes—namely, Department, Category and Price—automatically added based on the attributes present in the expression. As and when the expression changes with different attributes being included and deleted, appropriate columns are intelligently added and dropped accordingly. These attribute columns enable the user to compare various values of a single attribute for different products (such as ‘Price’ values, different ‘Colors’ and various ‘Brands’) used in the expression as well as compare against other attributes as well (such as Price vs. Brand or combined features of different items). This process simplifies reporting and eliminates reporting of attributes, which are not selected by the user during building of the expression. As an extension, columns for sub-expressions, such as “Category==Shirts”, could also be added to this table to further enhance the viewing of interesting attributes of the products in tabular view.

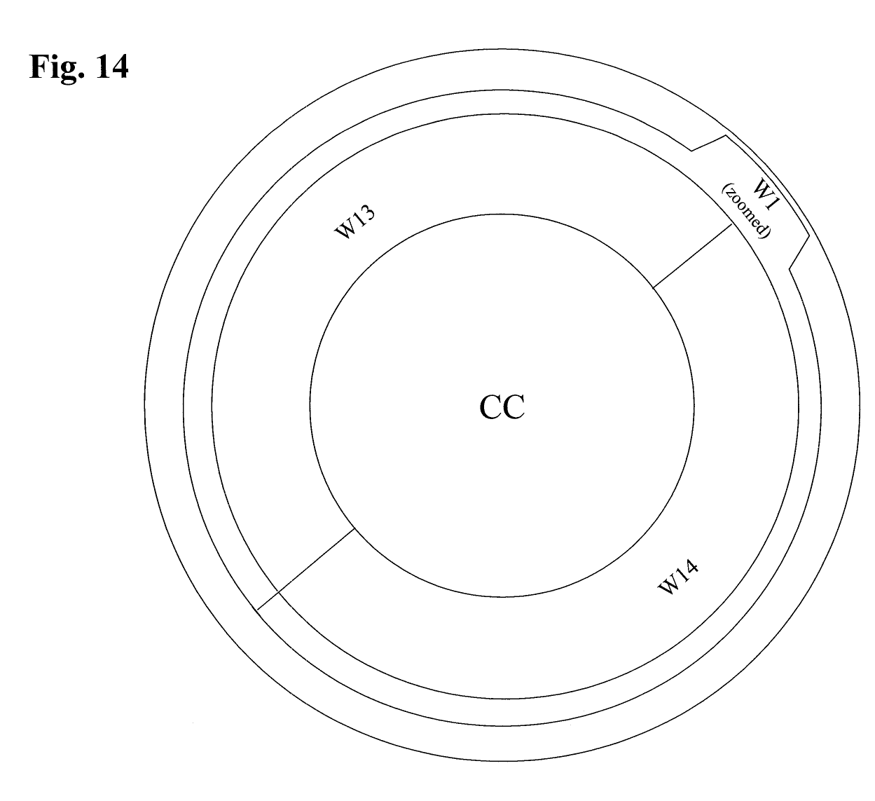

Wedges, particularly container wedges, can be zoomed in upon. Zooming a wedge causes that wedge to expand up to a size so as to fill up the entire area of the circle with all other surrounding wedges temporarily removed from visual appearance until zoom out is invoked. As an example, FIG. 14 is an illustration of the user interface after “W1” shown in FIG. 13 is zoomed. When a zoom-out operation is invoked, the appearance of the user interface reverts back to that shown in FIG. 13. This zooming operation can be invoked in a nested way and is not limited to only one level. For example, zoom-in can be repeatedly invoked until only one wedge occupies the entire circle. In FIG. 14, zoom-in can be invoked on “W13”; at that point, the entire circle will be occupied by W13. When zoom-out is invoked from this point, the appearance reverts to the arrangement of FIG. 14. Then, when zoom-out is invoked once again, the appearance reverts to the arrangement in FIG. 13.

A wedge may be maximized to get the largest possible view of it. This is similar to zooming, except that surrounding wedges are minimized without being removed from the view. For any surrounding container wedge in expanded state, its contained wedges are minimized first, and then the container wedge is collapsed to make as much space as necessary for the wedge being maximized. Similar to zooming, the original states of all wedges are preserved prior to a wedge being maximized and those states are restored once maximization is cancelled. Again, as in zooming, maximization also supports stacking multiple levels of maximization and restoration.

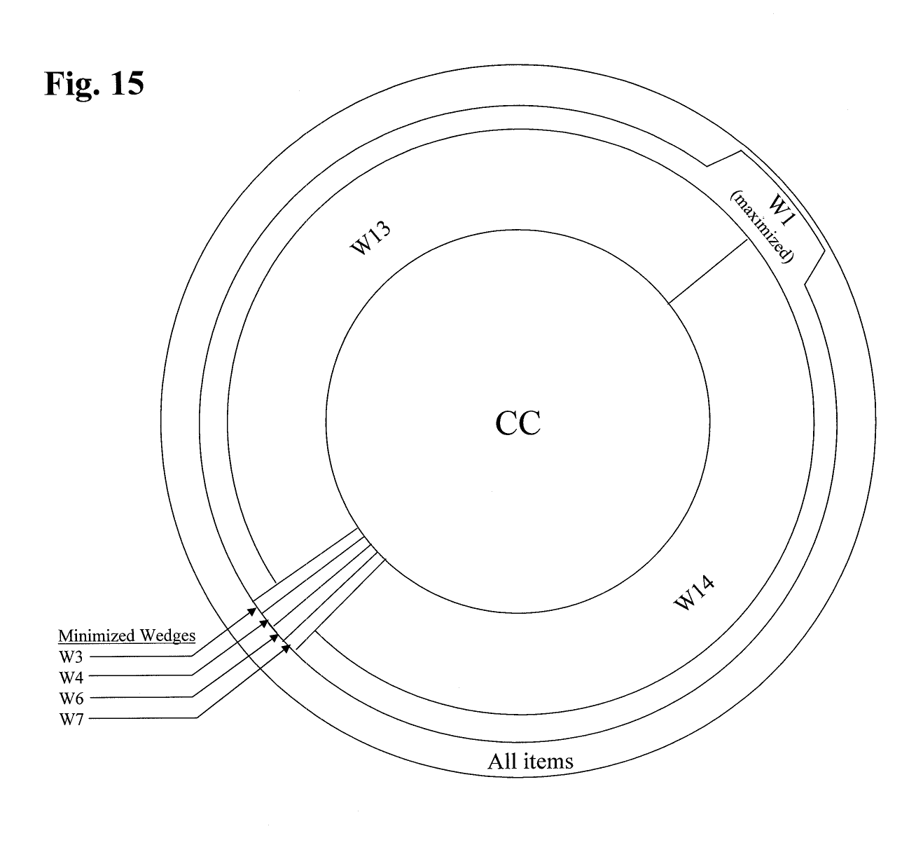

Wedge maximization enables easy single-page browsing wherein the effect is to retain the context (of the relative arrangement of wedges) instead of displaying a completely new page on the screen, as a typical website would do when a click action is invoked on any URL links in the page. An example of maximization is shown in FIG. 15, which shows the appearance of the user interface after “W1” in FIG. 13 was maximized.

Typical shopping websites support “wish list” features by which a consumer can add any interesting items seen during a browsing session. Although the wish list could be used for any other purpose than the purpose of wishing to buy the item, the wish list concept is normally used as a temporary private data storage holding items of interest for future handling. The relationships between various items in the wish list have not been utilized for the benefit of the consumers thus far. In embodiments of the present invention, wish lists are extended to exploit the relationships amongst items in the list in terms of their attributes and values. The UI/browser allows a user to build up multiple lists by flagging them appropriately with different flags. Anytime an interesting item is noticed, it can be flagged to be included into one or more “interest lists”. These interest lists are themselves termed as user-specific attributes and hence can be assigned to wedges in the browsing interface. By flagging an item to belong to an interest list, the user is assigning a new attribute (say, ‘interest-type’) to the item with value(s) of which list or lists it belongs to.

These items can then be used to infer their mostly shared attributes (only attributes which are common between most of the items) or cumulatively used attributes (a union of all unique attributes used between all the items) and values for use during the browsing session, creation of new wedges (as described above) or for direct use as part of the expression building in the central circle.

Wish lists could be built using not only individual items of interest, but also using expressions. Examining the outcome of matching items of an expression built, user could add the expression itself into the wish list in place of its individual matching items. This gives significant advantages to the user as it makes the wish list dynamic since expressions would result in matching items depending on the dataset of products the expressions are applied against. For example, an expression added to the wish list a month ago might yield different list of items today, if the global list of items have changed in the meantime. This is also useful in making the wish list user specific as opposed to website or vendor specific. Namely, a user can carry his/her wish list to a shopping site other than where it was originally built; to check out what kind of items the new site yields matching his expressions in the wish list. This makes wish list to be very powerful in quickly deciding whether a website is suitable to cater to the taste of the user or not.

Analysis of a wish list allows the user to understand the underlying parameters of a wish list. For example, an analysis can be done on the matching items of the wish list to explore most shared attributes of the matched items, items of unique characteristics (namely least common attributes between them), as well as statistical analysis such as mean, median, minimum, maximum values of certain attributes of the items such as price, dress size, color, etc.

Whenever any wedge or individual items come to visibility, it might be of interest to the user to pick and choose interesting attributes for further use (in the user's expression building). For example, refer again to FIG. 6A, which includes a list of items transferred to the central circle, one of which is under focus. On the right side of FIG. 6A, there is a details panel that provides more details of the item under focus. One can notice the description of the item with some of the words underlined. These words refer to some of the attributes associated with this item. As an example, ‘Anne Klein’ is highlighted, as this item belongs to an attribute ‘Brand’ with a value called ‘Anne Klein’. In addition it has attribute/value pairs of

Material_appearance=‘snakeskin’

Print_type=‘Snakeskin’

Material=‘Leather’

Upper_type=‘Any’

Style=‘Pump’

Toe_type=‘Peeptoe’

Heel_type=‘medium’

Style=‘Mary Jane’

Buckle=1

Strap_type=‘Any’

Strap_style=‘Buckle’

Lining=‘Faux Leather’

Etc.,

Etc.,

When these attributes are highlighted and visually presented to the user, they act as a cue and become handy for use in building expressions. In this case, for example, the user may drag and drop the ‘snakeskin’ attribute directly from the description to the central circle to add items (or excluding all other items not) having ‘snakeskin’ as one of their attributes or their values. This results in adding a sub-expression to the resultant expression of the central circle:

“(Material_appearance==‘Snakeskin’∥Print_type==‘Snakeskin’)” added with an OR (“∥”) operator (or with an AND (“&&”) operator for excluding others)

Similarly, another ‘peep toe’ could be dragged and dropped to create a new wedge (by itself or under another container wedge) accordingly.

This is just an example of how attributes could be highlighted to provide cues to the user to use them as appropriate (in creating wedges or supplementing expressions). This example is not intended to indicate that only the description portion of the item will have highlighted attributes or keywords. For example, in place of or in addition to the ‘description’, a list of all attributes and values the item belongs to explicitly can be displayed or highlighted as part of the title of the item thing brought to visibility.

The apparatus and method described and claimed herein can be used in many ways. The following is a summary of just some of the ways in which the apparatus and method can be used, and in particular the ways described herein by way of example. Some non-limiting assumptions have been made in order to simplify the description of the examples described. For example, it is assumed that whenever items related information such as results satisfying any given expression (built up during this session), details of items including their attributes and also global and context specific list of attributes are provided interactively by server components whose details are not discussed in this document.

The examples illustrated and described herein relate to specific online shopping scenarios, but embodiments are not so limited. Other non-limiting assumptions in the foregoing description include: dragging and dropping an attribute into the circle creates a wedge with the attribute's name and sets its explicitly assigned expression to be “(<Attribute>==Any), where <Attribute> is the dragged attribute; dragging and dropping a value of an attribute into the circle creates a wedge with the value's name and sets its explicitly assigned expression to be “(<Attribute><Value>), where <Attribute> is the attribute of the value and <Value> is the dragged value; the relationship between the Central Circle and other wedges to be ‘Accumulated OR’; the relationship between contained wedges of the same container wedge is ‘OR’; the relationship between contained wedge and its container wedge is ‘AND’; and a wedge could be flagged to “Invert” its results, namely ‘NOT’.

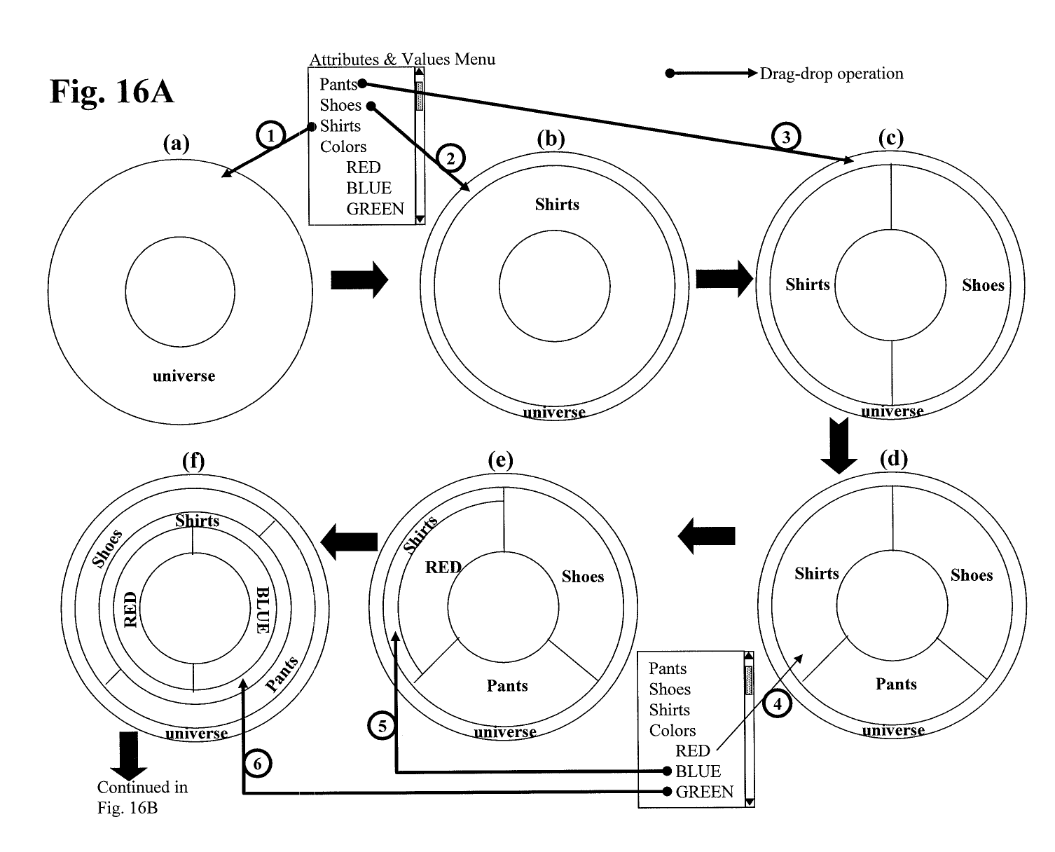

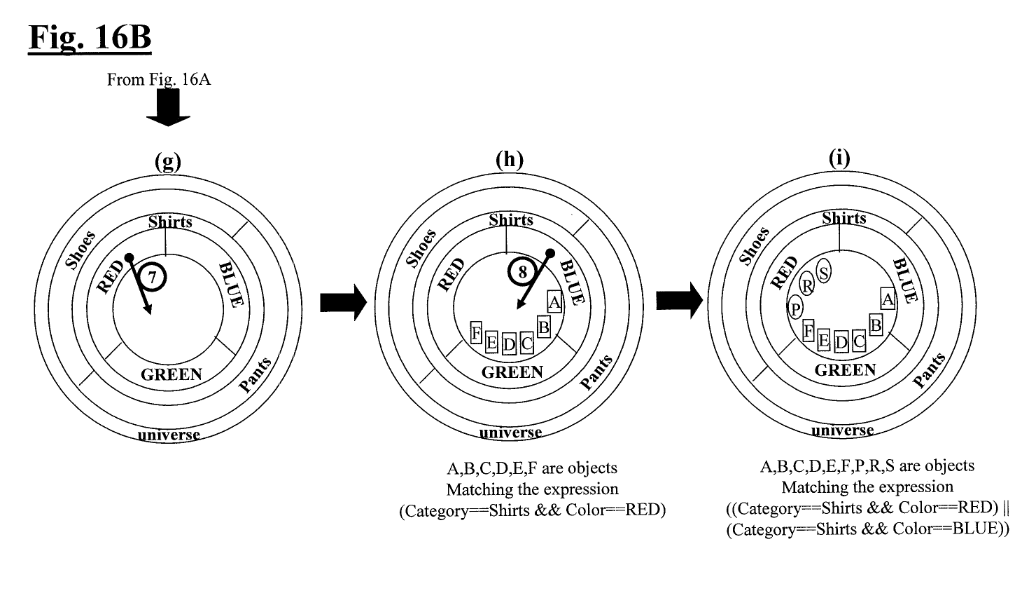

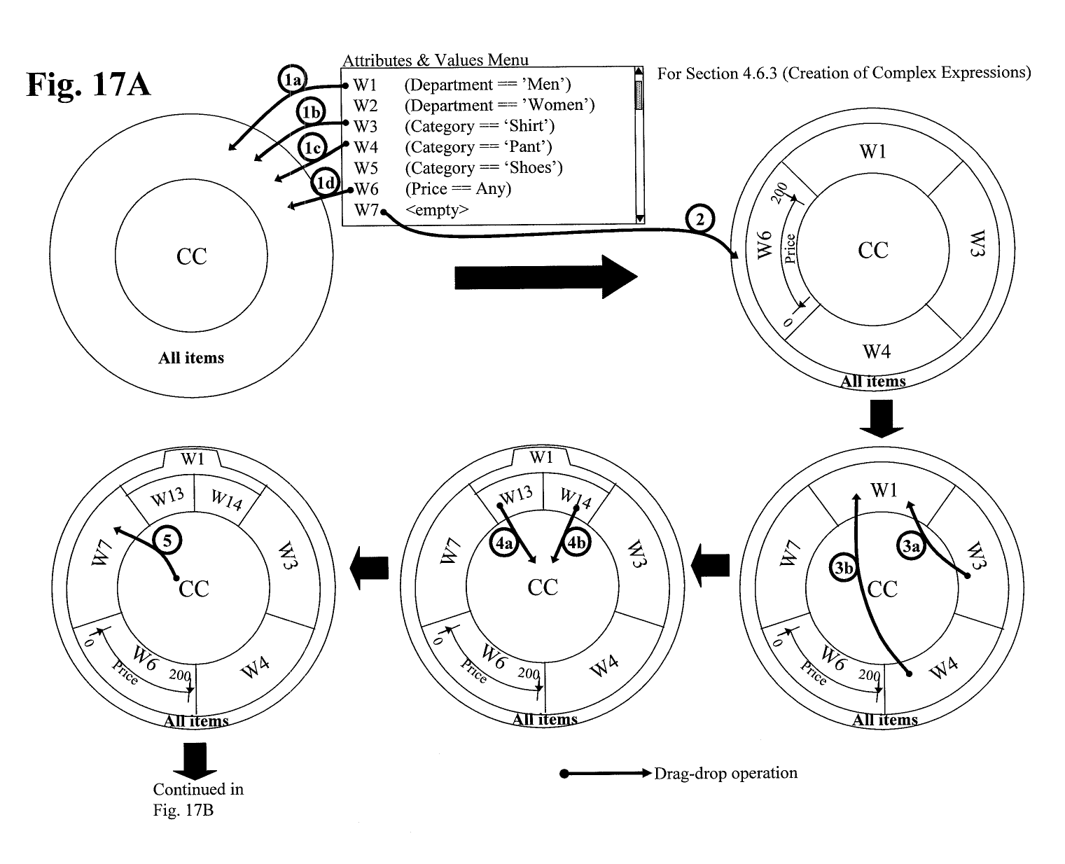

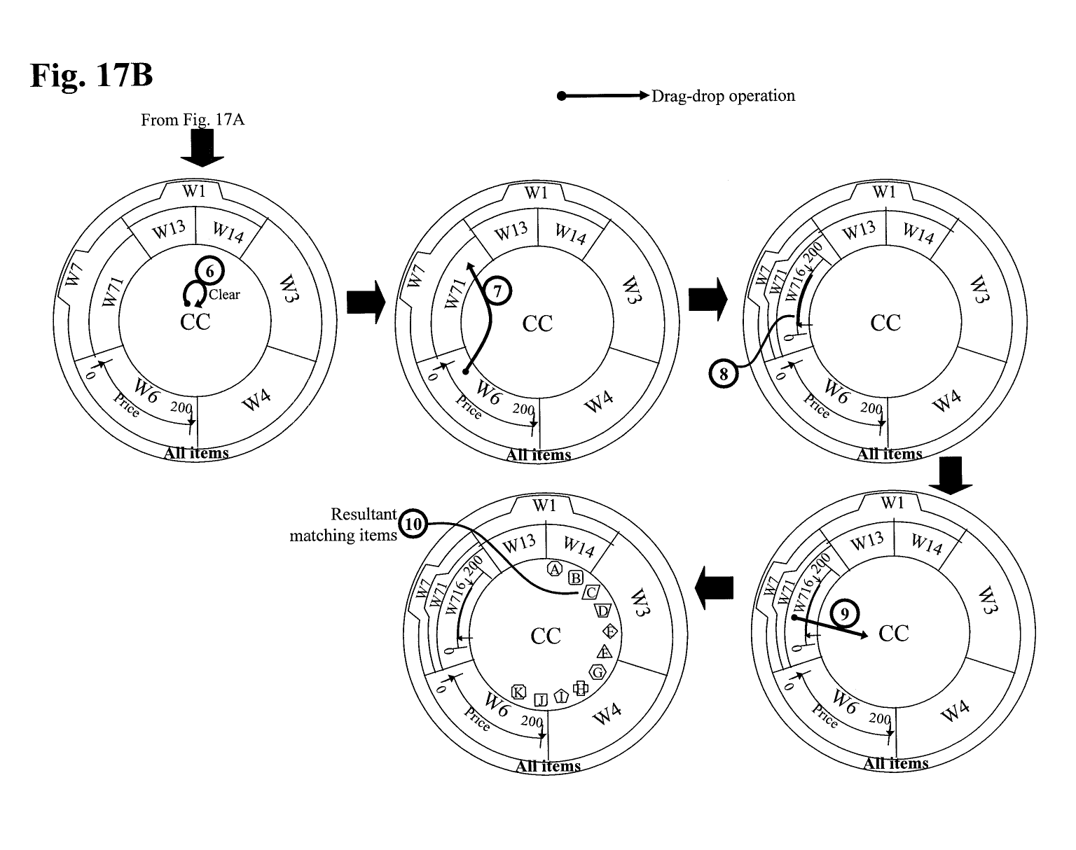

FIGS. 16A and 16B are diagrams showing a sequence of steps for creating a wedge using a container wedge placement and fitting method, as previously described. With reference to FIGS. 16A and 16B:
1) An empty ‘universe’ wedge is the default starting point (a). User could invoke a list of ‘Attributes & Values’ applicable for the universe to select attributes and related values. Some of the attributes are—pants, shoes, shirts, colors with values of red, blue and green, brands such as Nike, etc. At this point, the user drags and drops ‘Shirts’ into the universe.
2) At this point, the universe wedge becomes a container wedge and contains ‘Shirts’ as its contained wedge (b). Notice that Shirts is shown as a dominant one as it is more specific than the universe and hence more likely relevant to the central circle. Now user drags and drops ‘Shoes’ into the universe.
3) Now the universe is split into two—one for Shirts and the other for Shoes equally, as both are equal in level and equally likely candidates for selection in to the central circle (c). Now the user drags and drops ‘Pants’ into the universe.
4) Now the universe is equally split into 3 equal parts—one each for Shirts, Shoes and Pants (d). Now user intends to explore ‘Shirts’ further. Hence he drag and drops ‘Red’ under ‘Color’ into the ‘Shirts’ wedge. At this point Shirts gets bigger rank than Shoes and Pants as it is getting more focus from the user.
5) Because of the increased focus of Shirts, as well as holding an extra wedge within itself, it gets bigger share of the circle (but not yet getting big enough rank to occupy the whole circle) than Shoes and Pants (e). ‘Green’ occupies most of the ‘Shirts’ wedge, as it is more specific and likely candidate for the inner circle because of user's intention (of bringing it). Now the user wants to get ‘Blue’ into Shirts. Hence he drags ‘Blue’ and drops it into Shirts.
6) At this point because of continued focus of Shirts as well as more wedges coming into Shirts, Shirts' wedge increases in rank and ends up winning the entire ring and pushes other less focused wedges—Shoes and Pants—to the outer ring. Because of this necessitated change, a new ring is created by splitting the previous ring accordingly to accommodate Shoes and Pants. The Shirts wedge is split equally between Red and Blue wedges (f). Now the user wants to include ‘Green’ also into Shirts, and hence drags and drops it into Shirts.
7) Now the Shirts wedge is split into 3 equal wedges one for each of the Red, Blue and Green colors (g). They are equal because they are at the same level within Shirts as well as they have got equal focus so far. Shirts is further away from the central circle because its own specific colors are more focused and relevant than their aggregate. Shoes and Pants further away because of their less relevance (still relevant, because they are all part of the same aggregate of ‘life-style’ products and hence they are still likely candidates for being used. Now the user is ready to browse products. He wants to see all ‘Red Shirts’, hence he drags and drops the ‘Red wedge into the central circle.
8) Now products matching “(Color==‘Red’)” are retrieved from the server and displayed as icons around the edge of the central circle (h). Now the user drags and drops ‘Blue’ onto the central circle.
9) Now products matching “(Color==‘Red’∥Color ‘Blue’) are retrieved and shown in the central circle (this resultant expression is because of the Accumulated OR property of the central circle) (i).
Note that the container wedges here can also be shown as tabbed wedges like the ones in FIG. 10B

Embodiments of the claimed apparatus and method also include profiles and attributes (attributes were previously referred to). Profiles are the physical machine-readable and identifiable representations of the arrangement of the wedges and its properties including their corresponding absolute and explicitly assigned expressions. For example, the wedge arrangements in FIG. 13 can be converted into a profile. Similarly, any other user interface representations that show a state of a user's progress can be converted into profiles.

Profiles describe various wedges as well as their arrangement among themselves. Profiles can be physically saved and retrieved later to exactly reproduce the arrangement of wedges on the display. Since profiles are machine readable, they play a vital role in understanding how users build their wedges and what attributes are used and how and what kind of expressions are built to search for items.

Although each user's wedge arrangement and the expressions being built could be unique, converting the arrangement into profiles provide a way of sharing them among like-minded users. For example, arranging interesting attributes of a set of products like the ones in FIG. 12 could be useful to be saved in a profile for later retrieval by the same user to continue the product search or make someone else's search of the same or similar products easier by sharing the profile with them. Shared profiles also provide a healthy starting point for others to continue to improve or knowingly deviate from the starting point to explore unique set of products further.

Unlike typical bookmarks that websites provide for personal uses, profiles may not have any personal information in it at all. Also, bookmarks are set of loose referential items kept together because of the same type (such as URL links of different categories), whereas profiles keep structures and relationships around attributes and their usage (through expressions).

Profiles provide a single click-able link for the complete wedge arrangement. This makes sharing very simple, as any click-able link could be embedded or referenced easily in web pages, emails and any other sharable documents.

Use of profiles by various users can be monitored and accounted for by various entities, which can be used for gathering of statistics or for monetization purposes. One such monetization application is targeted advertisements. A profile may depict a particular browsing behavior, such as representing products satisfying a specific criterion (through expressions in wedges) or any other possible criteria (such as any specific selection of a set of wedges). Thus, advertisements can be targeted at users using the profile in certain specific ways.

Profiles can be stored in many different, known formats such as extensible markup language (XML). Some of the information stored is as follows:
Placement parameters of wedges;
Wedge belonging (container and its list of contained wedges);
Explicitly assigned expressions of wedges;
Displayable states of the wedges (such as minimize-state, maximize-state, zoom-state, color, carousels and their states, range-containers and their states); and
Relationships and operators between various wedges.

Profiles can be stored locally at the end user's machine in terms of files, databases, or cookies. Profiles can also be stored away from the user in a server located in the same or different machine, where they are retrievable from the same or some other user machine(s).

While profiles provide the arrangement of wedges, a browsing-context represents a machine-readable representation of a particular browsing or usage state of a profile in deriving a set of products. For example, FIG. 10A has a browsing-context state of its profile with items selected with an expression of

“((Category==‘Athletics & Outdoor’) &&
(Usage==‘Walking’∥
Usage==‘Running’∥
Usage==‘Golf Shoes’∥
Color==‘Any’))”

In addition, a browsing-context may also provide other browsing state information such as flagged items of interest, to what locations (which retailers, for example) this browsing-context is applicable etc. for the purposes of sharing.

When shared, browsing-contexts provide a very quick glance of a specific use of the profile without resorting to understanding the arrangement of wedges.

The linkage of a browsing-context with its profile allows a user who receives the browsing-context from someone else to refine the search or expression further to suit their needs and tastes. However, it is not necessary that the associated profile be changed. The associated profile is needed for further forwarding of the modified browsing-contexts to other users for subsequent uses. However, any browsing-context in isolation, without reference to any profiles, is still meaningful as it carries the resultant expression (for the selection of items), which is independent of the wedge arrangement, but dependent only on the attributes used. Hence, a provider of similar items, for example, might have to attend only to the resultant expression (hence the browsing-context) in order to cater the resultant items to the users without being concerned about how the browsing-context was built using the associated profile.

Browsing-contexts, like profiles, provide a single click-able link for browsing and product selection states. As before, this makes sharing very simple, as any clickable link can be embedded or referenced easily in web pages, emails and any other sharable documents. Users can provide link to their Profiles and Browsing-contexts to their friends and community about the products or items they are interested in and actively searching for.

Attributes have a universal nature. The association of attributes with wedges, and in turn the wedges' arrangement in profiles and the expressions involving attributes with browsing-contexts is universal in nature independent of providers, vendors and users of the same kind of items and services in a particular domain. As an example, in the domain of life-style products and shopping, the attributes and their characteristics can be kept to be uniform and independent between various vendors, providers, suppliers, manufacturers and users. There could be differences in the usage of some attributes such as different currencies for the same attribute called ‘Price’, but those could be bridged through predictable transformations between different usages. There could also be some culture specific and region specific attributes exclusively used in certain circumstances. At a minimum, same exact products carried by different vendors could have same set of attributes and values.

In such cases, where vendors carrying exactly the same or similar products of the same domain could share the attributes, profiles and browsing-contexts among themselves for collaboration purposes to utilize the same user base. In such cases, profiles and browsing-contexts built in one location (such as a website of a vendor/provider) can be applied or used in another location (website of another vendor/provider). This application of carrying over and using the attributes, profiles and/or browsing-contexts, with or without mapping, translations and transformations, is another aspect of the apparatus and method.

This usage of “learn and build once and apply anywhere any number of times” provides saving of lot of browsing time for the users as well as enable people to make easier and quicker decisions as the answers from different vendors are directly comparable. For example, a user browsing at Amazon.com™, trying to find a particular type of products has to learn how to navigate within Amazon.com. In case the products are not found and the user wants to look at JCPenny.com™, the user must start from scratch, learning about a new website in order to find similar merchandise; and so on for every other website as well.

Browsing-contexts can be used as triggers. As mentioned earlier, once a browsing-context is built using a profile, the profile is not needed for a provider/vendor to cater items matching the browsing-context's resultant expression to its user. Hence a user can submit a browsing-context to one or more providers as a trigger to request notification of any change that affects the outcome of the browsing-context (such as list of items matching the resultant expressions). For example, a user, after building a browsing-context and getting the list of items matching its resultant expression, might not be fully satisfied with the result (either the list of items is empty or the list is not interesting enough). In which case, he could set up a trigger for the browsing-context to alert him whenever a change condition is affected. Typical change conditions could be change in the list of items (such as, elimination of existing items, inclusion of newer items, change in total number of items, change in number of newer items, etc.), change in a particular period (such as weekend sale, etc.). Triggers can include those supported by vendors and websites for various purposes including ‘email alert’ for arrival of new emails to ‘price alert’ for a particular product, etc. Alerts for comprehensive collection of products satisfying an arithmetic and logical expression, especially expressions derived using profiles, is a feature of the apparatus and method.

Although explanation of the apparatus and method herein uses the example of an online shopping application, with shopping and selection of life-style products, the apparatus and method are not so limited. The claimed invention is applicable to any other areas in which there is a need for searching items that are classified in terms of their attributes. “Attribute” is meant to imply definable characteristics that might have different names, such as “tags”, “index terms”, “keywords”, “metadata”, “dictionary of words”, etc., to name a few.

Further applications for the apparatus and method are described in the following sections.

Customer support is another application for the apparatus and method. Customer support is very expensive if handled (through phone and/or email support) manually at the supporting end. In order to reduce the expenses, many techniques are followed such as layered support (wherein, free website database for manual browsing at the first, proactive bulk email updates when problems are noticed and interactive email support for a premium to phone support at the next level for a higher premium to on-site support at the highest), wherein, except at the first level (web-based problem/solution database for browsing) other levels involve human intervention from the supporting end. Many a times, human intervention is needed to understand the circumstances under which problems occurred and if the problem was previously solved for “similar” circumstances, support personnel direct them to any pre-defined solutions.

One way of reducing the human intervention is to enable customers to define their problems using well-defined attributes by the customers. Support personnel, in turn, could define their supported products and their known or reported problems and symptoms (fixable or not) in terms of well-defined attributes. Sometimes, searchable keywords are handy as mixed bag, in which case, such a search could be converted to an attribute like ‘matchword’ with list of keywords as a dictionary of enumerated string values for the ‘matchword’ attribute.

Once, relevant attributes are defined and used them in defining the products and problems, this apparatus, especially its user interface could be used by the customers to define their usage scenario as well as the encountered problems in terms of pre-defined attributes to locate already reported or fixable problems and thereby possible solutions for the defined problems. In the case of an unreported problem, the result of searching (the resultant expression built) for such a problem itself serves as the definition of the problem (equivalent to searching for a non-existing product in the domain of shopping using attributes) in terms of the existing attributes and their values.

As an example, consider problems related to a model of a digital camera:
10) Brightness of the LCD screen gets reduced considerably when snow or raindrop directly falls on the screen during dark
11) Memory card takes too long to write when the temperature is near freezing level

First, all products having problems (in this case, a particular model of a digital camera) should be defined in terms of attributes relating to various areas problems have been reported earlier. In this case, an attribute named as ‘product’ and the model name as one of its values; and another attribute ‘part’ with values named as ‘display screen’ and ‘memory card’. Similarly attributes have to be created related to product usage and application such as indoor/outdoor conditions, temperature, snowy, rainy, etc. Then the next step would be to define the above problems in terms of resultant expressions and list of involved attributes.

An example resultant expression for problem #1 above is:

“(Product==‘Model_XXX’ && Part ==‘LCD’ &&
(Climate ==‘Rainy’∥Climate==‘Snowy’) &&
(LCD_Condition==‘Wet’) &&
(LCD_Brightness==‘Low’)

and all other attributes assumed to be ‘Any’ meaning “don't care” (always match). And the problem #2 above becomes:

“(Product==‘Model_XXX’ && Part==‘MemoryCard’ &&
(Chillness==‘Low’∥Temperature<=40)

and all other attributes assumed to be ‘Any’ meaning “don't care” (always match). These are formed using minimum conditions as applicable to the product as known to the support personnel.

The customers not necessarily will define their problems identically. They might miss out some attributes of the usage—for example LCD_Condition==‘Wet’—in which case the problems defined would still match (partially) although other problems (matching their definition) might also get listed as potential ones matching the customers.

The customers might use additional attributes such as “(Exposure==‘Outdoors’)” which are to be treated as “don't care” for matching purposes as explained above. Since attributes are always provided by the system, there is no room for any ambiguities such as a choice of ‘Fading_display’ in place of ‘LCD_Brightness’. In the case of above problems, customers have no choice but to select only those simple expressions listed below as choices for explicitly assigning to various wedges:

“(Product==‘Model_XXX’)”

“(Part==‘LCD’)”

“(Part==‘MemoryCard’)”

“(Climate==‘Rainy’)”

“(Climate==‘Snowy’)”

“(Temperature<=40)”

“(Chillness==‘Low’)”

“(LCD_Condition==‘Wet’)”

“(LCD_Brightness==‘Low’)”

This is reasonable as far as reported problems are concerned, where the customer might check if any such problems have been reported and possible fixes exist. However, in order for the customers to define new problems not involving these attributes or simple expressions above, then human intervention is needed to capture the problem condition. Hence, it is advisable for the support personnel to define every attribute of their products where potential problems could occur as well as every usage condition in terms of their attributes and values. When such a situation is created, newer problems can be defined and reported automatically, as well as other customers reporting the same or similar problems would recognize the fact that they have been reported by some other customer—all these without any human intervention from the supporting personnel—a big savings for the supporting staff.

Internet search applications are another also suitable for the apparatus and method. The apparatus and method can be used as helper/front-end application to perform complex keyword search using standard search engines such as Yahoo!™, Google™ and MSN™. Typically, users type a linear list of known words possibly matching the aimed subject or web page. Then the next similar but edited linear list of words is given for search after looking at the result of the first search. Rarely do users resort to “Advanced Search” or search involving reserved keywords which mean a specific operation such as “AND”. This apparatus could be used as a user interface front end to form such complex search string and fire up ‘Advanced Search’ using keyword operators (such as “AND”, “OR”, “+”, “−”, etc.) in the backend. The search results are provided as items matching their resultant expression.

Searches are typically not faithfully preserved, particularly in for-free search applications. Some search engines provide a way of remembering the literal texts typed at their search box. the invention claimed and described herein enables users to build search profiles for various subjects and areas using wedges assigned with different keyword, tags and metadata of the items/web pages/documents they are looking for.

The apparatus and method can, as a starting point, provide a simple text box to fire up the search. Upon looking up the results, user could select and copy interesting keywords relevant to their search from the results and build up their wedges with simple expressions like “(Search_Keyword==‘<dragged_word>’)”, where <dragged_word> is the word or words dragged from the result page of the earlier search. The wedges could be quickly dragged and dropped onto each other and arranged in a way to create expression such as “(Search_Keyword==‘Grade 6’ && !(Search_Keyword==‘Math’))” to search for web pages or articles covering sixth grade related information other than ‘Math’. When interesting words, such as ‘Worksheet’ and ‘performance tests’ are noticed as part of the results of previous searches, could be dragged and dropped onto existing wedges or by themselves and subsequently added to the search by appropriately dragging and dropping the wedges into the Central Circle. In addition to enabling complex text search over internet to be easier and feasible, the wedge arrangement so created (in this case, for sixth grade related search involving ‘Math’ and non-Math as well as ‘Worksheets’ and ‘performance test’) could be preserved by saving it as a Profile and reused later or even shared with others who are interested in using similar searches.

The methods and apparatus disclosed herein include a system for searching and organizing data, the system comprising: a facilitator entity coupled to at least one network, the facilitator entity comprising at least one server; a plurality of data source entities coupled to the network, each data source entity comprising at least one database; a plurality of end user entities coupled to the network, each end user entity comprising a processor and a display unit; wherein the facilitator entity is configurable to serve a user interface (UI)/browser client via the network, wherein the UI/browser client is configurable to receive input from end users to direct searches of the data sources entities via the network, the input comprising manipulation of visible sections of the display, wherein UI/browser client is further configurable to use the input to construct expressions transparently to the end user, the searches resulting in a plurality of data objects.

In an embodiment, expressions comprise: query language expressions conditional expressions; search expressions; arithmetic expressions; and logic expressions.

In an embodiment, the facilitator serves the UI/browser client to each of the plurality of data source entities, wherein each served UI/browser client is executed on a data source entity.

In an embodiment, the facilitator serves the UI/browser client to each of the plurality of end user entities, wherein each served UI/browser client is executed on an end user entity.

In an embodiment, the UI/browser client resides on the facilitator entity, and wherein the UI/browser client is invoked remotely by end users and executed on the facilitator entity upon invocation.

In an embodiment, manipulation of visible sections comprises: the user dragging a visible section of the display from one or more data providers on the network and dropping the section into the visual format; presenting a drop-down menu from which the user can choose a “move” function comprising; keyboard input; voice input; touch screen input; and mouse input including drag-and-drop input.

In an embodiment, wherein dragging a first section onto a second section creates a new third section within the second, wherein expressions associated with the first section are transported to the second section.

In an embodiment, an expression is a function of a plurality of attributes, and wherein attributes are associated with data objects.

In an embodiment, the end user entities comprise handheld devices and laptop devices.

In an embodiment, the visual representation of the data is circular, and the visible sections comprise sections included in the circle.

In an embodiment, a section further comprises a carousel, wherein a carousel is a representation of matching items of a section displayed as a scrollable carousal within a wedge shaped-section.

In an embodiment, a section further comprises a range container comprising a graphical expression a range of characteristics including price, size, number.

In an embodiment, a section comprises a circle.

In an embodiment, a section comprises a segment of a circle including a radial distance, a radial thickness, a starting angle and a sweep angle.

In an embodiment, a section comprises a rectangle including a height, a width, an x-coordinate, and a y-coordinate.

In an embodiment, a section comprises one or more sections contained within it. In an embodiment, a section is configured to be collapsed so as to hide sections contained within it.

In an embodiment, sections comprise a rank, wherein the rank of a section is based on a number of data objects matching an underlying expression associated with the section.

In an embodiment, the rank of a section is derived from one or more attributes associated with the section.

In an embodiment, the rank is further derived based on one or more attributes associated with other sections.

In an embodiment, sections comprise container sections and contained sections, and wherein a section is associated with a rank that comprises a derivation of attributes of data within a section.

In an embodiment, a section comprises a collector section, and wherein multiple sections are moved into the collector section in order to build one or more expressions simultaneously.

In an embodiment, a physical location of a section conveys significance, including a rank of a section and a type of a section.

In an embodiment, an expression comprises one or more operators selected from a group comprising: logical operators; conditional operators; arithmetic operators; and database operators.

In an embodiment, a section can be associated with one or more expressions.

In an embodiment, a location of a section affects the expression.

In an embodiment, location of a section with one associated expression within another section with another associated expression results in a third expression.

Methods and apparatus disclosed herein further include a user interface (UI) method for browsing, the UI comprising: receiving user input regarding data to be located for via a network; assembling the data; presenting the data in a predetermined visual format, the format comprising visible sections that include a visual representation of the data, the sections further implying non-visual information associated with the data; receiving user input comprising manipulation of the visible sections; and interpreting the user input based on the resultant rearrangement of the visual format and further upon the non-visual information.

In an embodiment, non-visual information includes expressions comprising: query language expressions; search expressions; conditional expressions; arithmetic expressions; and logic expressions.

In an embodiment the method further comprises, based on the interpretation, forming a search expression transparently to the user.

In an embodiment, the visible section comprises a visible border defining the section.

In an embodiment, a visible section comprises a group of characters separated by white space, the characters comprising letters, numbers, and symbols.

In an embodiment, manipulation of visible sections comprises the user dragging a visible section from one or more data providers on the network to the visual format.

In an embodiment, the visual representation of the data is circular, and the visible sections comprise wedges included in the circle.

In an embodiment, a section comprises a circle.

In an embodiment, a section comprises a segment of a circle including a radial distance, a radial thickness, a starting angle and a sweep angle.

In an embodiment, a section comprises a rectangle including a height, a width, an x-coordinate, and a y-coordinate.

In an embodiment, a section comprises one or more sections contained within it.

In an embodiment, a section is configured to be collapsed so as to hide sections contained within it.

In an embodiment, sections comprise container sections and contained sections.

In an embodiment, the method further comprises minimizing a section, wherein minimizing comprises reducing a size of the section in relationship to peer sections, wherein peer section are wedges within a same container section.

In an embodiment, the method further comprises maximizing a section, wherein maximizing comprises reducing sizes of peer sections.

In an embodiment, the method further comprises tabbing a wedge section, wherein tabbing includes displaying visible tab on a section, and wherein tabbed sections comprise: container sections; and non-container sections which show all section properties within their area.

In an embodiment, the method further comprises a section comprises a collector section, and wherein multiple sections are moved into the collector section in order to build one or more expressions simultaneously.

In an embodiment, the rank of a section is based on a number of data objects matching an underlying expression associated with the section.

In an embodiment, the rank is further derived based on one or more attributes associated with other sections.

In an embodiment, the physical location of a section is derived using the rank of a section and a type of a section.

In an embodiment, the rank of a section is further derived from one or more attributes of the section.

In an embodiment, an expression is a function of a plurality of attributes, and wherein attributes are associated with data objects.

In an embodiment, an expression comprises: conditional operators; logical operators; arithmetic operators; and database operators.

In an embodiment, a section can be associated with one or more expressions.

In an embodiment, a location of a section affects the expression.

In an embodiment, location of a section with one associated expression within another section with another associated expression results in a third expression.

Methods and apparatus disclosed herein include an electronic data organization method, comprising: receiving user input including user manipulation of electronically displayed data items; based on the user manipulation of displayed data items, automatically creating one or more expressions, wherein an expression comprises combinations of attributes of data items and includes arithmetic expressions, logic expressions, lists, and query expression, and wherein expressions are associated with sections of the display; storing expressions; storing at least one browsing-context, wherein a browsing-context comprises, wherein an expression is associated with one or more designated sections of the display; storing at least one profile, wherein a profile comprises appearance details for a display comprising sections.

In an embodiment, text on the display is construed to have an implicit expression of “expr(A)={<TEXT_ATTR>==<text string of the region>}”.

In an embodiment, the electronically displayed data items include pictorial representations of physical objects, and text.

In an embodiment, the electronically displayed data items represent data stored on one or more databases on the network.

In an embodiment, manipulating comprises dragging and dropping objects to various section of a computer display.

In an embodiment, the method further comprises: a user sending a profile to another user; and the other user accesses the profile to experience a context stored in the profile.

In an embodiment, the method further comprises storing a wishlist that contains data items and expressions, wherein the wishlist is transferable to different users.

Methods and apparatus disclosed herein further include a computer-readable medium, having instructions stored therein, that when executed in a processor causes a user interface (UI) method to be executed, the UI method comprising: receiving user input regarding data to be searched for via a network; presenting data in a predetermined visual format, the format comprising visible sections that include a visual representation of the data, the sections further implying non-visual information associated with the data; receiving user input comprising manipulation of the visible sections; and interpreting the user input based on the resultant rearrangement of the visual format and further upon the non-visual information.

In an embodiment, the UI method further comprises, based on the interpretation, forming an expression transparently to the user.

In an embodiment, expressions comprise: query language expressions; search expressions; conditional expressions; arithmetic expressions; and logic expressions.

In an embodiment, the visible section comprises a visible border defining the section.

In an embodiment, manipulation of visible sections comprises the user dragging a visible section from one or more data providers on the network to the visual format.

In an embodiment, the visual representation of the data is circular, and wherein the visible sections comprise wedges included in the circle.

In an embodiment, a section comprises a circle.

In an embodiment, a section comprises a segment of a circle including a radial distance, a radial thickness, a starting angle and a sweep angle.

In an embodiment, a section comprises a rectangle including a height, a width, an x-coordinate, and a y-coordinate.

In an embodiment, a section comprises one or more sections contained within it.

In an embodiment, a section is configured to be collapsed so as to hide sections contained within it.

In an embodiment, sections comprise container sections and contained sections, and wherein a section is associated with a rank that comprises a derivation of attributes of data within a section.

In an embodiment, a section comprises a collector section, and wherein multiple sections are moved into the collector section in order to build one or more expressions simultaneously.

In an embodiment, a physical location of a section conveys significance, including a rank of a section and a type of a section.

In an embodiment, the rank of a section is based on a number of data objects matching an underlying expression associated with the section.

In an embodiment, the rank of a section is further derived from one or more attributes of the section.

In an embodiment, an expression is a function of a plurality of attributes, and wherein attributes are associated with data objects.

In an embodiment, an expression comprises logical operators.

In an embodiment, an expression comprises conditional operators.

In an embodiment, a section can be associated with one or more expressions.

In an embodiment, a location of a section affects the expression.

In an embodiment, location of a section with one associated expression within another section with another associated expression results in a third expression.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize. The various operations described may be performed in a very wide variety of architectures and distributed differently than described. In addition, though many configurations are described herein, none are intended to be limiting or exclusive.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Computer-readable media include any data storage object readable by a computer including various types of compact disc: (CD-ROM), write-once audio and data storage (CD-R), rewritable media (CD-RW), DVD (Digital Versatile Disc” or “Digital Video Disc), as well as any type of known computer memory device. Such computer readable media may store instructions that are to be executed by a computing device (e.g., personal computer, personal digital assistant, PVR, mobile device or the like) or may be instructions (such as, for example, Verilog or a hardware description language) that when executed are designed to create a device (GPU, ASIC, or the like) or software application that when operated performs aspects described above. Accordingly, the inventors reserve the right to add additional claims after filing the application to pursue such additional claim forms for other aspects of the method and system.

What is claimed is:

1. A system for searching and organizing data, the system comprising:
a facilitator entity coupled to at least one network, the facilitator entity comprising at least one server;
a plurality of data source entities coupled to the network, each data source entity comprising at least one database;
a plurality of end user entities coupled to the network, each end user entity comprising a processor and a display unit;
wherein the facilitator entity is configurable to serve a user interface (UI)/browser client via the network, wherein the UI/browser client is configurable to receive input from end users to direct searches of the data sources entities via the network, the input comprising manipulation of visible sections of the display, wherein UI/browser client is further configurable to use the input to construct expressions transparently to the end user, the searches resulting in a plurality of data objects.

2. The system of claim 1, wherein expressions comprise:
query language expressions
conditional expressions;
search expressions;
arithmetic expressions; and
logic expressions.

3. The system of claim 1, wherein the facilitator serves the UI/browser client to each of the plurality of data source entities, wherein each served UI/browser client is executed on a data source entity.

4. The system of claim 1, wherein the facilitator serves the UI/browser client to each of the plurality of end user entities, wherein each served UI/browser client is executed on an end user entity.

5. The system of claim 1, wherein the UI/browser client resides on the facilitator entity, and wherein the UI/browser client is invoked remotely by end users and executed on the facilitator entity upon invocation.

6. The system of claim 1, wherein manipulation of visible sections comprises:
the user dragging a visible section of the display from one or more data providers on the network and dropping the section into the visual format;
presenting a drop-down menu from which the user can choose a “move” function comprising;
keyboard input;
voice input;
touch screen input; and
mouse input including drag-and-drop input.

7. The system of claim 1, wherein dragging a first section onto a second section creates a new third section within the second, wherein expressions associated with the first section are transported to the second section.

8. The system of claim 1, wherein an expression is a function of a plurality of attributes, and wherein attributes are associated with data objects.

9. The system of claim 1, wherein the end user entities comprise handheld devices and laptop devices.

10. The system of claim 1, wherein the visual representation of the data is circular, and the visible sections comprise sections included in the circle.

11. The system of claim 1, wherein a section further comprises a carousel, wherein a carousel is a representation of matching items of a section displayed as a scrollable carousal within a wedge shaped-section.

12. The system of claim 1, wherein a section further comprises a range container comprising a graphical expression a range of characteristics including price, size, number.

13. The system of claim 1, wherein a section comprises a circle.

14. The system of claim 1, wherein a section comprises a segment of a circle including a radial distance, a radial thickness, a starting angle and a sweep angle.

15. The system of claim 1, wherein a section comprises a rectangle including a height, a width, an x-coordinate, and a y-coordinate.

16. The system of claim 1 wherein a section comprises one or more sections contained within it.

17. The system of claim 16, wherein a section is configured to be collapsed so as to hide sections contained within it.

18. The system of claim 17, wherein sections comprise a rank, wherein the rank of a section is based on a number of data objects matching an underlying expression associated with the section.

19. The system of claim 18, wherein the rank of a section is derived from one or more attributes associated with the section.

20. The system of claim 18, wherein the rank is further derived based on one or more attributes associated with other sections.

21. The system of claim 16, wherein sections comprise container sections and contained sections, and wherein a section is associated with a rank that comprises a derivation of attributes of data within a section.

22. The system of claim 1 wherein a section comprises a collector section, and wherein multiple sections are moved into the collector section in order to build one or more expressions simultaneously.

23. The system of claim 1 wherein a physical location of a section conveys significance, including a rank of a section and a type of a section.

24. The system of claim 1, wherein an expression comprises one or more operators selected from a group comprising:
logical operators;
conditional operators;
arithmetic operators; and
database operators.

25. The system of claim 24, wherein a section can be associated with one or more expressions.

26. The system of claim 24, wherein a location of a section affects the expression.

27. The system of claim 24, wherein location of a section with one associated expression within another section with another associated expression results in a third expression.

28. A user interface (UI) method for browsing, the UI comprising:
receiving user input regarding data to be located for via a network;
assembling the data;
presenting the data in a predetermined visual format, the format comprising visible sections that include a visual representation of the data, the sections further implying non-visual information associated with the data;
receiving user input comprising manipulation of the visible sections; and
interpreting the user input based on the resultant rearrangement of the visual format and further upon the non-visual information.

29. The method of claim 28, wherein non-visual information includes expressions comprising:
query language expressions;
search expressions;
conditional expressions;
arithmetic expressions; and
logic expressions.

30. The method of claim 28, further comprising, based on the interpretation, forming a search expression transparently to the user.

31. The method of claim 28, wherein the visible section comprises a visible border defining the section.

32. The method of claim 28, wherein a visible section comprises a group of characters separated by white space, the characters comprising letters, numbers, and symbols.

33. The method of claim 28, wherein manipulation of visible sections comprises the user dragging a visible section from one or more data providers on the network to the visual format.

34. The method of claim 28, wherein the visual representation of the data is circular, and the visible sections comprise wedges included in the circle.

35. The method of claim 28, wherein a section comprises a circle.

36. The method of claim 28, wherein a section comprises a segment of a circle including a radial distance, a radial thickness, a starting angle and a sweep angle.

37. The method of claim 28, wherein a section comprises a rectangle including a height, a width, an x-coordinate, and a y-coordinate.

38. The method of claim 28 wherein a section comprises one or more sections contained within it.

39. The method of claim 38, wherein a section is configured to be collapsed so as to hide sections contained within it.

40. The method of claim 38, wherein sections comprise container sections and contained sections.

41. The method of claim 38, further comprising minimizing a section, wherein minimizing comprises reducing a size of the section in relationship to peer sections, wherein peer section are wedges within a same container section.

42. The method of claim 41, further comprising maximizing a section, wherein maximizing comprises reducing sizes of peer sections.

43. The method of 41, further comprising tabbing a wedge section, wherein tabbing includes displaying visible tab on a section, and wherein tabbed sections comprise:
container sections; and
non-container sections which show all section properties within their area.

44. The method of claim 28 wherein a section comprises a collector section, and wherein multiple sections are moved into the collector section in order to build one or more expressions simultaneously.

45. The method of claim 44, wherein the rank of a section is based on a number of data objects matching an underlying expression associated with the section.

46. The system of claim 44, wherein the rank is further derived based on one or more attributes associated with other sections.

47. The method of claim 28 wherein a physical location of a section is derived using the rank of a section and a type of a section.

48. The method of claim 46, wherein the rank of a section is further derived from one or more attributes of the section.

49. The method of claim 30, wherein an expression is a function of a plurality of attributes, and wherein attributes are associated with data objects.

50. The method of claim 49, wherein an expression comprises:
conditional operators;
logical operators;
arithmetic operators; and
database operators.

51. The method of claim 49, wherein a section can be associated with one or more expressions.

52. The method of claim 49, wherein a location of a section affects the expression.

53. The method of claim 49, wherein location of a section with one associated expression within another section with another associated expression results in a third expression.

54. An electronic data organization method, comprising:
receiving user input including user manipulation of electronically displayed data items;
based on the user manipulation of displayed data items, automatically creating one or more expressions, wherein an expression comprises combinations of attributes of data items and includes arithmetic expressions, logic expressions, lists, and query expression, and wherein expressions are associated with sections of the display;
storing expressions;
storing at least one browsing-context, wherein a browsing-context comprises, wherein an expression is associated with one or more designated sections of the display;
storing at least one profile, wherein a profile comprises appearance details for a display comprising sections.

55. The method of claim 54, wherein text on the display is construed to have an implicit expression of “expr(A)={<TEXT_ATTR>==<text string of the region>}”.

56. The method of claim 54, wherein the electronically displayed data items include pictorial representations of physical objects, and text.

57. The method of claim 54, wherein the electronically displayed data items represent data stored on one or more databases on the network.

58. The method of claim 54, wherein manipulating comprises dragging and dropping objects to various section of a computer display.

59. The method of claim 54, further comprising:
a user sending a profile to another user; and
the other user accesses the profile to experience a context stored in the profile.

60. The method of claim 54, further comprising storing a wishlist that contains data items and expressions, wherein the wishlist is transferable to different users.

61. A computer-readable medium, having instructions stored therein, that when executed in a processor causes a user interface (UI) method to be executed, the UI method comprising:
receiving user input regarding data to be searched for via a network;
presenting data in a predetermined visual format, the format comprising visible sections that include a visual representation of the data, the sections further implying non-visual information associated with the data;
receiving user input comprising manipulation of the visible sections; and
interpreting the user input based on the resultant rearrangement of the visual format and further upon the non-visual information.

62. The computer-readable medium of claim 61, the UI method further comprising, based on the interpretation, forming an expression transparently to the user.

63. The computer-readable medium of claim 62, wherein expressions comprise:
query language expressions;
search expressions;
conditional expressions;
arithmetic expressions; and
logic expressions.

64. The computer-readable medium of claim 61, wherein the visible section comprises a visible border defining the section.

65. The computer-readable medium of claim 61, wherein manipulation of visible sections comprises the user dragging a visible section from one or more data providers on the network to the visual format.

66. The computer-readable medium of claim 61, wherein the visual representation of the data is circular, and wherein the visible sections comprise wedges included in the circle.

67. The computer-readable medium of claim 61, wherein a section comprises a circle.

68. The computer-readable medium of claim 61, wherein a section comprises a segment of a circle including a radial distance, a radial thickness, a starting angle and a sweep angle.

69. The computer-readable medium of claim 61, wherein a section comprises a rectangle including a height, a width, an x-coordinate, and a y-coordinate.

70. The computer-readable medium of claim 61 wherein a section comprises one or more sections contained within it.

71. The computer-readable medium of claim 70, wherein a section is configured to be collapsed so as to hide sections contained within it.

72. The computer-readable medium of claim 70, wherein sections comprise container sections and contained sections, and wherein a section is associated with a rank that comprises a derivation of attributes of data within a section.

73. The computer-readable medium of claim 61 wherein a section comprises a collector section, and wherein multiple sections are moved into the collector section in order to build one or more expressions simultaneously.

74. The computer-readable medium of claim 61 wherein a physical location of a section conveys significance, including a rank of a section and a type of a section.

75. The computer-readable medium of claim 74, wherein the rank of a section is based on a number of data objects matching an underlying expression associated with the section.

76. The computer-readable medium of claim 75, wherein the rank of a section is further derived from one or more attributes of the section.

77. The computer-readable medium of claim 62, wherein an expression is a function of a plurality of attributes, and wherein attributes are associated with data objects.

78. The computer-readable medium of claim 77, wherein an expression comprises logical operators.

79. The computer-readable medium of claim 77, wherein an expression comprises conditional operators.

80. The computer-readable medium of claim 77, wherein a section can be associated with one or more expressions.

81. The computer-readable medium of claim 77, wherein a location of a section affects the expression.

82. The computer-readable medium of claim 77, wherein location of a section with one associated expression within another section with another associated expression results in a third expression.
